(19) United States
(12) Patent Application Publication
(10) Pub. No.: US 2025/0112967 A1
(43) Pub. Date: Apr. 3, 2025

(54) SEMANTIC COMMUNICATIONS CONTROL AND MANAGEMENT

(71) Applicant: Apple Inc., Cupertino, CA (US)

(72) Inventors: Saeideh Parsaei Fard, Cupertino, CA (US); Ahmed M. Soliman, Munich (DE); Bernd Wurth, Landsberg am Lech (DE); Bernhard Raaf, Neuried (DE); Matthias Sauer, San Jose, CA (US); Sabine Roessel, Munich (DE)

(21) Appl. No.: 18/893,323

(22) Filed: Sep. 23, 2024

Related U.S. Application Data
(60) Provisional application No. 63/541,650, filed on Sep. 29, 2023.
(60) Provisional application No. 63/541,697, filed on Sep. 29, 2023.
(60) Provisional application No. 63/541,915, filed on Oct. 2, 2023.

(51) Int. Cl. H04L 67/1095; H04L 5/00; H04L 43/0823

(52) U.S. Cl. CPC H04L 67/1095; H04L 5/0048; H04L 43/0847

(57) ABSTRACT

A method performed by an SMCE is provided. The method includes receiving, from at least one of a TX UE or an RX UE, semantic data corresponding to a semantic communications session between the TX UE and the RX UE. The SMCE is communicatively coupled to the TX UE and the RX UE. The method includes determining, based at least on the received data, a semantic distortion corresponding to the semantic communications session. The method includes synchronizing, with at least one of the TX UE or the RX UE, semantic data corresponding to the semantic communications session. A method performed by a UE is also provided.

### CLAIM OF PRIORITY

This application claims priority under 35 U.S.C. § 119 (e) to U.S. Patent Application Ser. No. 63/541,650, filed on Sep. 29, 2023, U.S. Patent Application Ser. No. 63/541,697, filed on Sep. 29, 2023, and U.S. Patent Application Ser. No. 63/541,915, filed on Oct. 2, 2023, the entire contents of each of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Traditional wireless communications focus on improving the accuracy of symbol transmissions. For example, a transmitter (TX) device, such as a TX user equipment (UE), encodes information into a stream of symbols according to a predefined protocol and transmits the encoded symbols via one or more wireless channels. Correspondingly, a receiver (RX) device, such as an RX UE, receives the stream of symbols and decodes the symbols to recover the transmitted information. Because the transmission is typically susceptive to noise and interference, the information symbols are often transmitted with redundant symbols for error checking and/or correction.

### SUMMARY

In accordance with one aspect of the present disclosure, a method performed by a Semantic Measurement and Control Entity (SMCE) is provided. The method includes receiving, from at least one of a TX UE or an RX UE, semantic data corresponding to a semantic communications session between the TX UE and the RX UE. The SMCE is communicatively coupled to the TX UE and the RX UE. The method includes determining, based at least on the received data, a semantic distortion corresponding to the semantic communications session. The method includes synchronizing, with at least one of the TX UE or the RX UE, semantic data corresponding to the semantic communications session.

In accordance with one aspect of the present disclosure, a method is provided. The method includes obtaining a TX sematic distortion indicator (SDI) between a TX UE and an apparatus. The method includes obtaining an RX SDI between the RX UE and the apparatus. The method includes determining, based at least on one of the TX SDI or the RX SDI, a semantic distortion between the TX UE and the RX UE. The method includes determining one or more network parameters corresponding to at least one of the TX UE or the RX UE. The method includes determining (i) a first performance metric based on the TX SDI, and (ii) a second performance metric based on the RX SDI. The method includes determining a third performance metric and a fourth performance metric based on the one or more network parameters. The method includes managing a semantic communications session between the TX UE and the RX UE based at least on the first performance metric, the second performance metric, the third performance metric, and the fourth performance metric.

In accordance with one aspect of the present disclosure, a method is provided. The method includes synchronizing, by an apparatus configured to manage semantic communications corresponding to a first UE, semantic data of the apparatus with semantic data of one or more neighboring apparatuses. The one or more neighboring apparatuses are configured to manage semantic communications corresponding to a second UE. The method includes synchronizing the semantic data of the apparatus with semantic data of the first UE. The method includes causing the first UE to establish a semantic communications session with the second UE.

In accordance with one aspect of the present disclosure, a method is provided. The method includes receiving semantic data from a plurality of candidate TX UEs in a plurality of semantic communications sessions between the plurality of candidate TX UEs and at least one RX UE, wherein the semantic data describe an environment. The method includes determining, from the semantic data, one or more features of the environment. The method includes determining that the at least one RX UE have access to the one or more features. The method includes selecting, based on one or more diversity or multiplexing parameters, at least one TX UE from the plurality of candidate TX UEs. The method includes transmitting the semantic data received from the at least one TX UE to the at least one RX UE. The method includes causing the at least one RX UE to reconstruct a semantic message based on the semantic data received from the at least one TX UE.

One or more operations of the above methods can be performed by one or more processors of an apparatus, such as an SMCE.

In accordance with one aspect of the present disclosure, a method is provided. The method includes transmitting, by a first UE and to a semantic control apparatus, semantic data corresponding to a semantic communications session between the first UE and a second UE. The method includes synchronizing the semantic data with the semantic control apparatus.

One or more operations of the above method can be performed by one or more processors of a UE.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2A illustrates a semantic communications system, according to some implementations.

FIG. 2B illustrates interaction between a semantic communications layer and other layers in a semantic communications system, according to some implementations.

FIG. 3 illustrates a block diagram of a semantic measurement and control entity (SMCE), according to some implementations.

FIG. 4A illustrates logical links between an SMCE and layers involved in semantic communications, according to some implementations.

FIG. 4B illustrates a control plane architecture of a semantic communications system, according to some implementations.

FIGS. 5A and 5B each illustrate a procedure for calculating a semantic distortion indicator (SDI), according to some implementations.

FIG. 5C illustrates a procedure of transmitting pilot signals between UEs and an SMCE, according to some implementations.

FIGS. 6A-6K each illustrate a scenario of communication quality between a TX UE, an SMCE, and an RX UE, according to some implementations.

FIGS. 7A and 7B each illustrate an architecture in which multiple SMCEs are connected, according to some implementations.

FIG. 8 illustrates partition of data in a knowledge base (KB) of an SMCE, according to some implementations.

FIG. 9 illustrates a procedure for KB synchronization between a UE and an SMCE, according to some implementations.

FIG. 10 illustrates a procedure for KB synchronization between two SMCEs, according to some implementations.

FIG. 11 illustrates a car platooning system in which autonomous vehicles communicate in semantic communications sessions, according to some implementations.

FIG. 12 illustrates control plane modules and tasks that support multi-user (MU) semantic communications, according to some implementations.

FIG. 13 illustrates a procedure for establishing MU semantic communications, according to some implementations.

FIG. 14 illustrates example semantic system information elements, according to some implementations.

FIGS. 15A-15K illustrate a plurality of example scenarios of reconstructing a message based on MU semantic transmissions, according to some implementations.

FIGS. 16-20 each illustrate a flowchart of an example method, according to some implementations.

FIG. 21 illustrates a UE, according to some implementations.

FIG. 22 illustrates an access node, according to some implementations.

In the figures, like numerals indicate like components. Unless expressly stated, broken lines do not suggest that any components in the figures are optional or not part of the illustrated embodiments. Instead, the broken lines may be used to indicate functional or structural relationships between illustrated components, as would be readily understood by one of ordinary skill in the art.

### DETAILED DESCRIPTION

In traditional wireless communications, communication quality is typically measured based on the number of symbols recoverable/recovered by the RX device. For a given set of encoded symbols, increasing the number of symbols recoverable/recovered at the RX means transmitting more redundant symbols for error checking and/or correction. This can increase the consumption of network resources and the complexity of devices.

In contrast to traditional wireless communications, semantic communications focus on conveying the desired meaning (“perception” or “context”) in the transmitted symbols. A traditional wireless receiver attempts to recover information objectively encoded in each individual symbol, whereas a semantic wireless receiver attempts to infer the subjective perception that the transmitter device intends to convey. For example, when a TX device wants to convey weather information to an RX device, instead of transmitting the exact temperature value, the TX device can perceive that the weather is cold, warm, or hot, and transmit its perception of the weather to the RX device in semantic messages. Correspondingly, the RX device can interpret the weather condition based on the semantic information received from the TX device. A communications session for transmitting and receiving semantic messages can be referred to as a semantic communications session. The interpretation by the TX device can be referred to as semantic encoding, while the interpretation by the RX device can be referred to as semantic decoding. When the TX device and the RX device interprets the same semantic information differently, semantic distortion can occur. Semantic distortion can be measured as SDI, which can be a metric of end-to-end performance of communication networks in scenarios of semantic and/or task-oriented communication involving artificial intelligence or machine learning.

In the above example of weather reporting, the semantic encoding and decoding of the weather condition rely on semantic knowledge of the TX device and the RX device, respectively. The semantic knowledge can be stored in one or more storage devices, referred to as knowledge bases (KBs), in the form of, e.g., data indicating a correspondence between a temperature value and a weather condition. To ensure that the RX device interprets the semantic information as intended by the TX device, the TX device and the RX device may have their respective semantic knowledge synchronized. Otherwise, for a given temperature value (e.g., 15° C.) transmitted, if the weather condition interpreted by the TX device (e.g., warm) is different from that interpreted by the RX device (e.g., cold), then the semantic communications session can be considered to suffer a semantic distortion that negatively affects the communication quality.

The semantic distortion is conceptually different from the symbol errors caused by noise and interference (often measured as bit error rate [BER], frame error rate [FER], block error rate [BLER], or packet error rate [PER]) in traditional wireless communications. In traditional wireless communications, the protocol for encoding and decoding the information into symbols is known to both the TX device and the RX device regardless of the actual meaning of the application information. That is, the errors at the network layers, including media access control (MAC) and physical (PHY) layers, can be decoupled from the error at the application layer. By contrast, in semantic communications, because the TX device and the RX device seek knowledge from the application to interpret the symbols, the application layer is not decoupled from the network layers when semantic distortion is measured. Rather, semantic distortion can be a result of KB difference between the TX device and the RX device or misinterpretation of the meaning of information due to environmental changes or incomplete observation. Accordingly, it is desirable for the network layer to receive feedback in one or more loops from the application such that the semantic communication over a network is aligned with the execution of the application.

This disclosure is made in light of the challenges faced by existing semantic communications techniques. As described in detail below, implementations of this disclosure provide one or more mechanisms for apparatuses in semantic communications sessions to synchronize KBs, address semantic distortions, and coordinate with other entities in the network. With one or more features provided herein, a semantic communications network can be formed with improved communication quality, efficiency, and scalability, and can be used in many applications that require complex network structure and high data speed.

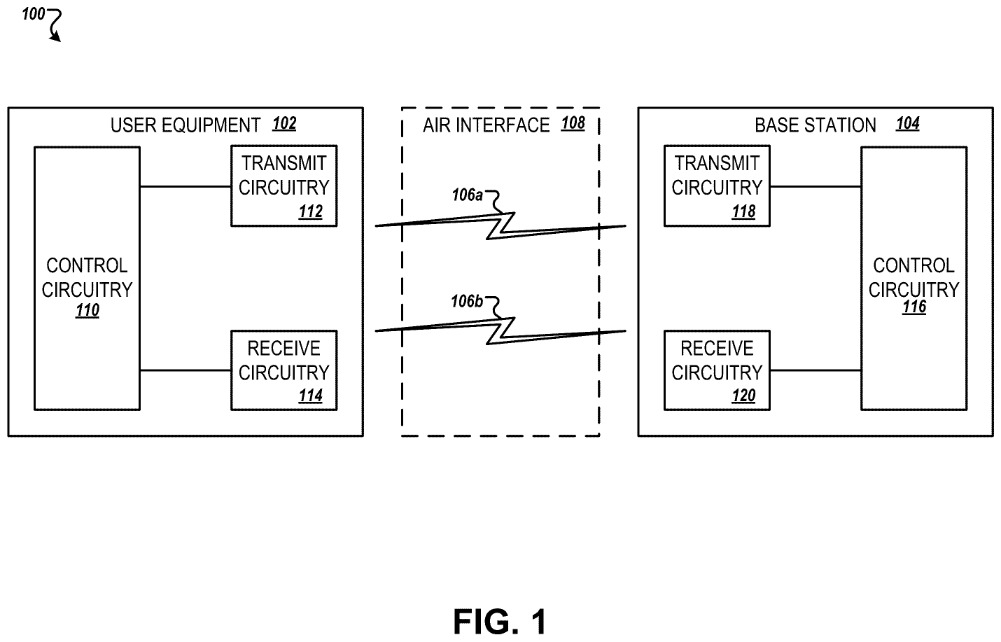

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can perform semantic encoding or decoding and control the transmit circuitry 112 and/or the receive circuitry 114 to communicate with an SMCE.

The transmit circuitry 112 can perform various operations described in this specification. For example, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, an E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

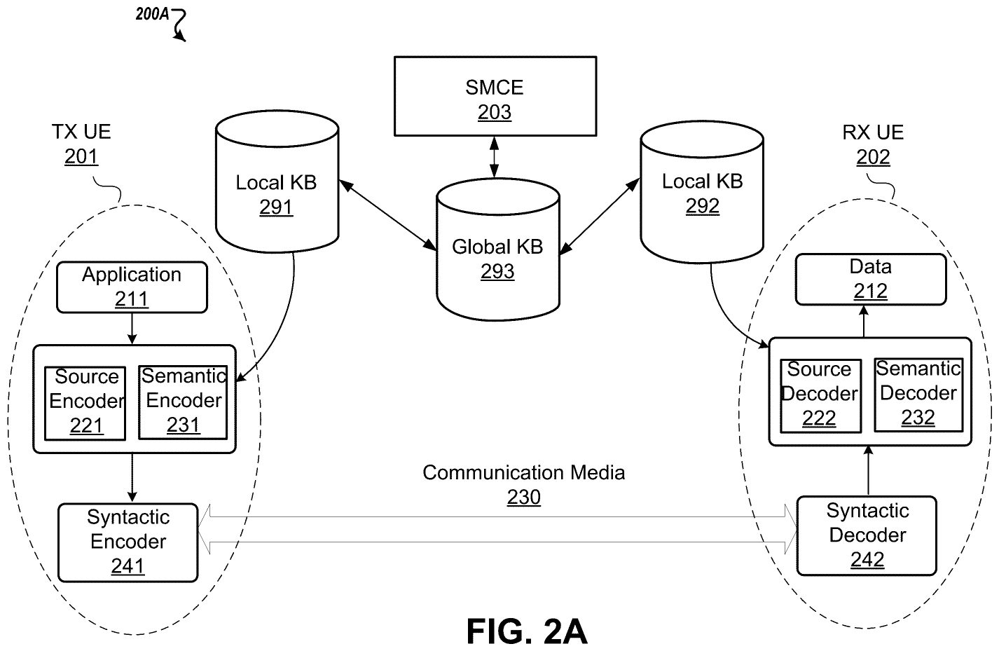

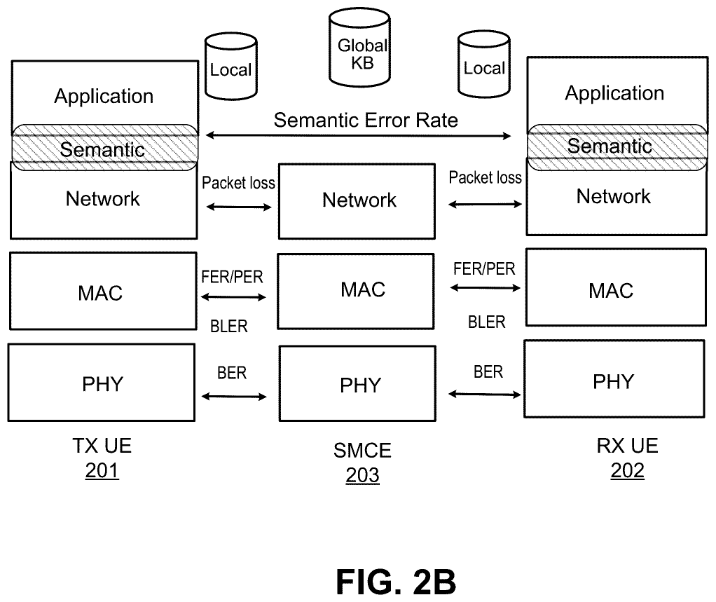

FIG. 2A illustrates a semantic communications system 200A, according to some implementations. Semantic communications system 200A includes TX UE 201 and RX UE 202, which communicate through communication media 230. Communication media 230 can include protocol stacks at at least one of a network layer, a medium access control (MAC) layer, or a physical (PHY) layer.

Each of TX UE 201 and RX UE 202 can have structures and functions similar to those of UE 102 of FIG. 1. In addition to source encoder 221, which can encode a message for traditional, non-semantic communications, TX UE 201 has semantic encoder 231, which can obtain semantic information (e.g., application data to be transmitted) from application 211 and generate a semantic message. TX UE 201 also has syntactic encoder 241, which can encode the message, traditional or semantic, according to the syntax of a communication protocol. The syntactically-encoded message is then transmitted, via communication media 230, to RX UE 202. Correspondingly, RX UE 202 has syntactic decoder 242, which syntactically-decodes the message received from TX UE 201. Depending on whether the syntactically-decoded message is a traditional message or a semantic message, RX UE 202 uses source decoder 222 or semantic decoder 232 to decode the message and obtain application data 212.

TX UE 201 and RX UE 202 are each associated with a local KB, 291 and 292, respectively, which can be implemented on one or more storage devices that are part of the UEs or communicatively coupled (e.g., on a cloud) to the UEs. Local KBs 291 and 292 can provide information such as rules and parameters for semantic encoder 232 and semantic decoder 232 to encode and decode, respectively, semantic messages.

Semantic communications system 200A also includes SMCE 203, which can be implemented as a network entity, such as a component of a base station or other entity in the access network, that coordinates the semantic communications between TX UE 201 and RX UE 202. SMCE 203 has global KB 293, which can be partially or fully accessible to local KBs 291 and 292 to provide semantic context for semantic communications between TX UE 201 and RX UE 202. In general, a global KB can store semantic information accessible by not only the storing SMCE but other devices in communication with the SMCE. A local KB, on the other hand, can store information that is specific to the storing device. SMCE 203 can be configured to perform a variety of functions, such as synchronizing semantic context with local KBs 291 and 292, managing KB versions and compatibility of local KBs 291 and 292, and detecting and tracking semantic distortion. In some implementations, SMCE 203 can be virtualized with functions performed by one or more control nodes of a network or the cloud.

In some implementations, SMCE 203 is a consolidation of functionalities and tasks of managing and controlling semantic communications. SMCE 203 can be a network function (NF) implemented in a virtual machine, instance, or software agent in the network's control plane. For example, SMCE 203 can have a logical connection to the NFs in 5G. SMCE can be connected to application function (AF), network data analytics function (NWDAF), access and mobility management function (AMF), session management function (SMF), session management function (SMF), and any other new procedure and network functions to establish the semantic communications or network processes. The task elements of SMCE 203 can be implemented in different physical or virtual entities of the network. For example, SDI measurement and root cause analysis, described below, can be part of the edge cloud for latency reasons. Synchronization among global and local KBs can be implemented directly in the entities hosting AMF. With a proposed modular view of the tasks and functionalities, any hierarchical implementation of SMCE 203 can be supported to enhance efficiency and reduce signaling among network entities. SMCE 203 can be capsulated in a procedure inside of 6G and, as a virtual machine or instance, can be implemented over an application server.

FIG. 2B illustrates interactions between a semantic communications layer and other layers in semantic communications system 200A, according to some implementations. As illustrated, each of TX UE 201 and RX UE 202 has an application layer, a network layer, a MAC layer, and a PHY layer, which are traditionally implemented by communication systems, e.g., according to the open systems interconnection (OSI) model. Correspondingly, SMCE 203 (or the network entity which implements SMCE 203) also has a network layer, a MAC layer, and a PHY layer for processing syntactically-encoded messages transmitted between TX UE 201 and RX UE 202. As also illustrated, each of TX UE 201 and RX UE 202 has a semantic layer that is between and overlaps the application layer and the network layer. The network layer, the MAC layer, and the PHY layer are collectively referred to as networking layers.

The reason of having the semantic layer overlap the application layer and the networking layers is related to the error detection and correction mechanisms at these layers. In traditional communications, a syntactic encoder with its prior knowledge is available or the reconstruction of the message is just related to the alphabet of the source code. The error at the application level can be decoupled from the networking layers since the alphabet of source coding is already known. Therefore, each layer adds its own header and calculates its own error rate among peer-to-peer communication. Consequently, there are different strategies, such as hybrid automatic repeat request (HARQ), for error compensation. Although some communications systems are configured with adaptive coding, the transmission parameters of the layers, not the applications, are adaptively changed.

By contrast, in semantic communications, the semantic encoder does not perform a one-to-one mapping, which is known in advance, between elements of a message to code alphabets. Rather, messages in semantic communications are interpreted to convey the context, and the interpretation is not based on a known, one-to-one mapping. Accordingly, the application layer cannot be decomposed from the networking layers and the error at the application layer is not directly related to the errors at the networking layers. For example, BER may or may not add errors to the decoded semantic data since the semantic interpretation may have the capacity to reconstruct the message even from a noisy (e.g., with high BER, FER, BLER, or PER) message. As another example, even if a received message has no syntax error, it is still possible to have semantic errors between the transmitted message and the received message due to, e.g., KB differences and misinterpretation, environmental changes, and partial observation. Accordingly, the networking layers may obtain feedback from the application layer to ensure that the semantic communication is aligned with the goal of the application.

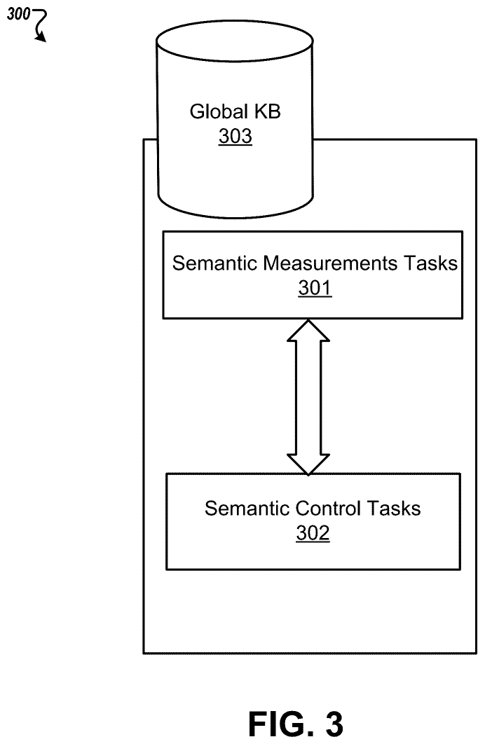

FIG. 3 illustrates a block diagram of an SMCE 300, according to some implementations. SMCE 300, which is coupled to global KB 303, can be similar to SMCE 203 in FIGS. 2A and 2B that operates to, e.g., track and control semantic errors of semantic communications and manage and synchronize global and local KBs.

SMCE 300 has semantic measurement tasks 301 and semantic control tasks 302. Semantic measurement tasks 301 can include one or more tasks for, e.g., tracking semantic distortion, selecting an equation of calculating SDI, activating a feedback mode for SDI measurement, and threshold adjustments for SDI. Semantic control tasks 302 can include one or more tasks for, e.g., providing a unified view to handle semantic distortion in the semantic communications network by adjusting hyper parameters. The adjustment can include, e.g., adjust time intervals for sending pilot signals at both syntax and networking levels (e.g., to derive channel state information [CSI], HARQ time, and acknowledgement [ACK]/not-acknowledgement [NACK] procedures) or semantic levels (e.g., time for perceptions and semantic inference modes). The adjustment can also include resource management based on the SDI and the priorities of the services (e.g., applications).

In some implementations, some of semantic measurement tasks 301 and semantic control tasks 302 are distributed among network components and are not necessarily included within SMCE 300. For example, some of semantic control tasks 302 can be implemented within SMCE 301 at the control plane while some of semantic measurement tasks 301 can be implemented within a UE at the data plane.

The role of SCME 300 varies depending on the state of a semantic communications session. For example, at the initiation of a semantic communications session, SCME 300 can manage a global KB, provide an interface to register device capabilities for semantic communication, and/or provide an interface and protocols to synchronize local KBs with the global KB through a semantic pilot sequence. During an active semantic communications session, SCME 300 can perform SMCE measurement to track semantic distortion during the session, and/or provide an interface to register information about session-specific semantic distortion metrics, e.g., by registering a metric function or metric values. After a semantic communications session finishes, SCME 300 can keep the history of the session in a semantic repository or an operations and maintenance center (OMC) of the network, call the history of application before executing admission control, and/or decide to share or not to share the history of the session with an application controller.

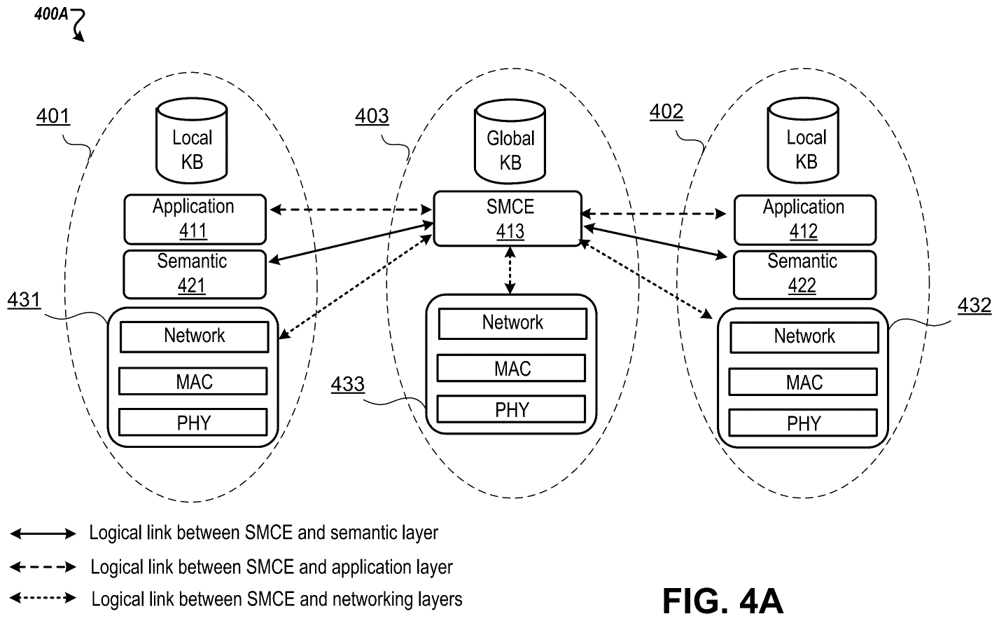

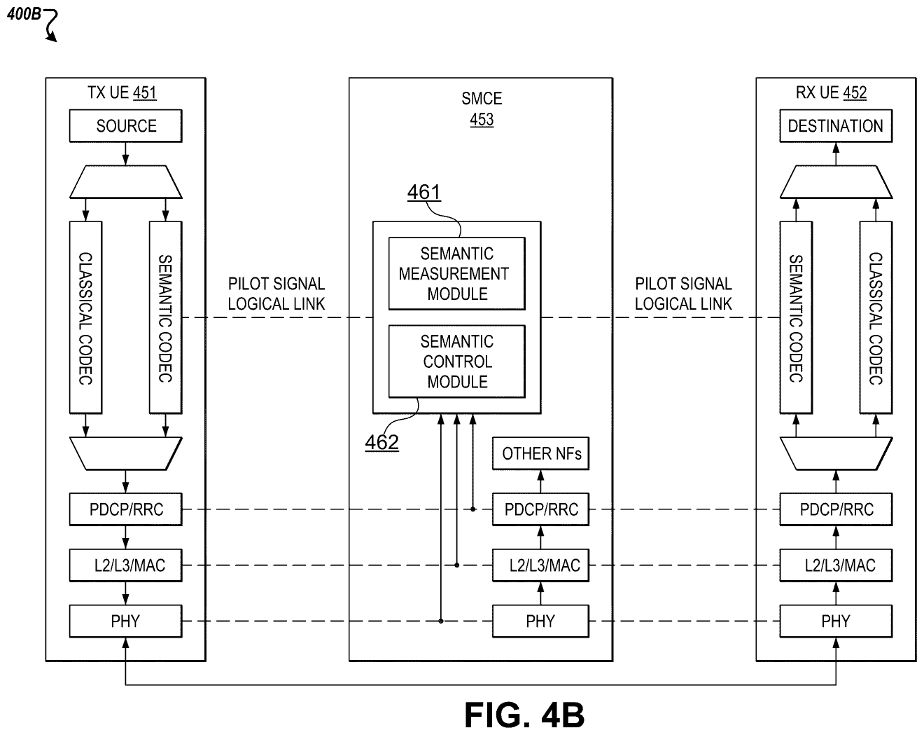

FIG. 4A illustrates logical links between SMCE 413 and layers involved in semantic communications of semantic communications system 400A, according to some implementations. Semantic communications system involve UEs 401 and 402 and network entity 403 which implements SMCE 413. As illustrated, UEs 401 has application layer 411, semantic layer 421, and networking layers 431. Similarly, UEs 402 has application layer 412, semantic layer 422, and networking layers 432. Additionally, SMCE 413 has or is coupled to network entity 433.

As illustrated, SMCE 413 establishes a logical link with application layer 411, semantic layer 421, and networking layers 431 of UE 401. SMCE 413 also establishes a logical link with application layer 412, semantic layer 422, and networking layers 432 of UE 402. Additionally, SMCE 413 also establishes a logical link with networking layers 433 of its own. View these logical links, SMCE 413 can adjust transmission parameters of the networking and application layers jointly, e.g., according to the available resources, application requests, and network situations. For example, during a semantic task, SMCE 413 can tune a networking pilot duration and/or a semantic pilot duration to adjust the age of information (e.g., history of session) in the application and adjust the network time intervals for sending pilot signals to obtain CSI.

In addition to the logical links, one or more feedback loops can be implemented among the layers of each of UEs 401 and 402 and/or among the layers of SMCE 403. As described above, the feedback loops are desirable to align the semantic communication with the execution of the application. These feedback loops can be autonomous based on artificial intelligence (AI) algorithms.

FIG. 4B illustrates a control plane architecture of a semantic communications system 400B, according to some implementations. Consistent with FIGS. 2A, 2B, 3, and 4A, SMCE 453 of semantic communications system 400B has semantic measurement module 461 and semantic control module 462 in communication with networking layers (e.g., packet data convergence protocol [PDCP], radio resource control [RRC], Layer 2, Layer 3, MAC, and PHY). The networking layers of SMCE 453 process information corresponding to networking layers of TX UE 451 and RX UE 452. For example, at the PHY layer, SMCE 453 obtains CSI between SMCE 453 and TX UE 451 and RX UE 452; at the RRL or MAC layer, SMCE 453 obtains BER and modulation information; at PDCP or RRC layer, SMCE 453 obtains FER and quality of experience (QoE) class information. SMCE 453 also utilizes the logical links with TX UE 451 and RX UE 452 to transmit and receive pilot signals.

As described above, semantic communications can be susceptive to semantic distortion due to, e.g., discrepancies between the KBs of the TX UE and the RX UE. An SMCE has multiple approaches to track and manage semantic distortion, a few examples of which are provided below.

A first approach is based on semantic pilot and probe signals and can be used in applications such as speech and image processing and human-to-human (H2H) communications. Periodically, the SMCE generates a pilot message supplied with un-encoded pilot information. The SMCE then sends the pilot message to the TX UE. The SMCE also semantically encodes the pilot information based on the global KB and sends the semantically-encoded pilot message to the RX UE. Upon receiving the pilot message, the TX UE semantically encodes the pilot message based on its local KB and transmits the pilot message, which semantically encoded based on the TX UE's local KB, back to the SMCE. On the other hand, upon receiving the pilot message semantically encoded based on the global KB, the RX UE decodes, based on the RX UE's local KB, the message to reconstruct the semantic information generated supplied by the SMCE and transmit the reconstructed semantic information to the SMCE. If the semantically-encoded pilot message received from the TX UE substantially matches the semantically-encoded pilot message generated by the SMCE, then it can be determined that the TX UE's local KB substantially matches the SMCE's global KB. Similarly, if the reconstructed semantic information received from the RX UE substantially matches the semantic information generated by the SMCE, then it can be determined that the RX UE's local KB substantially matches the SMCE's global KB. If the lobal KB of either UE substantially mismatches the SMCE's global KB, then it can be determined that substantial semantic distortion exists and measures can be taken to reduce the semantic distortion.

A second approach is based on semantic trajectory checking in a task with a specified goal (e.g., reaching a desired state), and can be used in applications such as machine-to-machine (M2M) communications. Under this approach, the SMCE has one or more reference trajectories of the actions of the machines and/or states of the environment to reach the goal of the task. The one or more trajectories can be derived based on the global KB of the SMCE or by an application controlled in online or offline manners. For example, the SMCE can check the actions of the machines or the state of the environment during one or more stages of the task to determine any deviation from reference or estimated trajectories. The amount of deviation can correspond to the significance of semantic distortion.

An SMCE can use the SDI as an indicator of deviation from the target situation of effective communication with semantics or the semantic pilot distortion. An SMEC can use SDI as a criteria to decide semantic control plane functionalities and procedures. The SMCE can mathematically define the SDI based on variables such as networking layer parameters, a priority indicator of a task, a pilot message of the task, the difference between an encoded message at the TX UE and a decoded message at the RX UE (or the difference between semantically coded messages of the TX UE and reconstructed messages of the RX UE). The SMCE can receive the calculated SDI from UEs, machines, or application controllers that participate in semantic communications. By considering parameters such as CSI, available resources, and existing services, the SMCE can handle the semantic distortion by adjusting system parameters, switching from semantic to traditional source coding, assigning more resources to the services, or performing admission control.

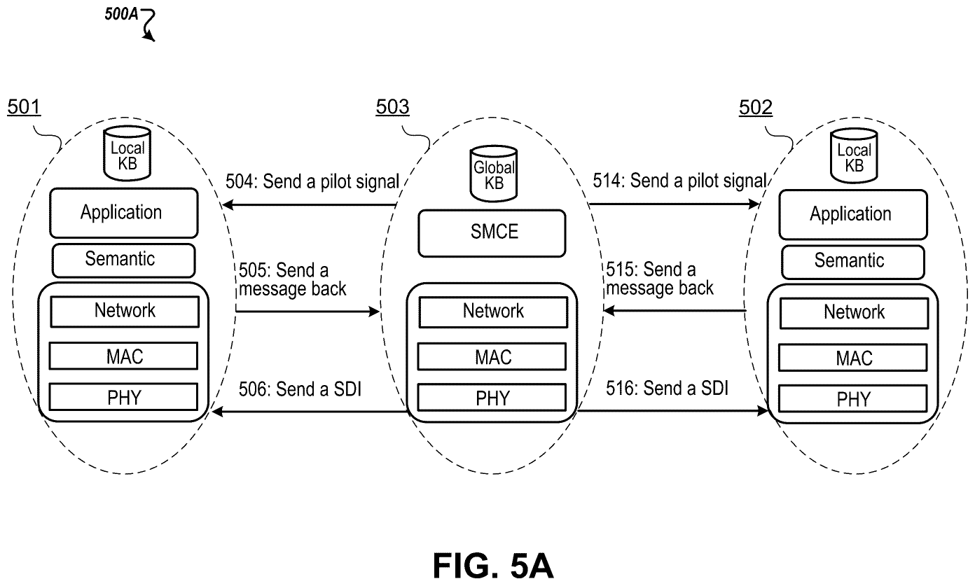

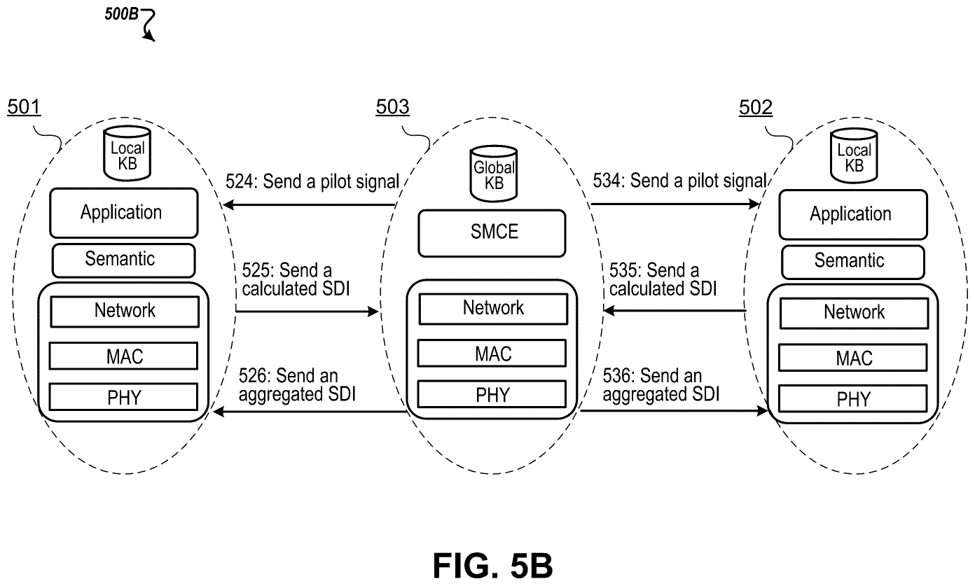

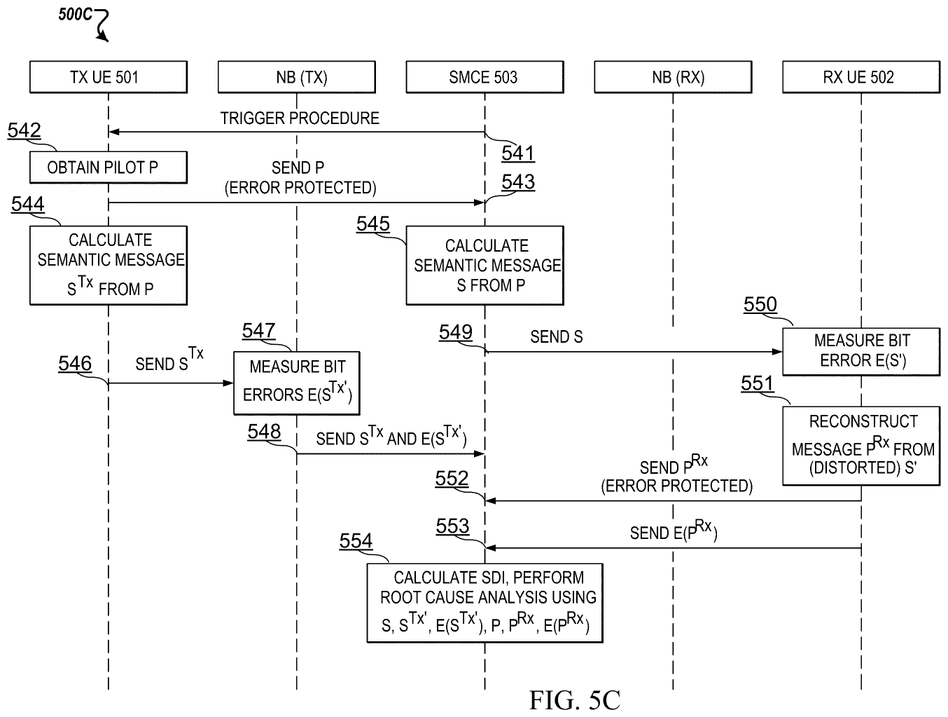

FIGS. 5A and 5B each illustrate a procedure for calculating a SDI using pilot signals, according to some implementations. Procedure 500A of FIG. 5A illustrates a scenario where the SDI is calculated by SMCE 503, while procedure 500B of FIG. 5B illustrates a scenario where the SDI is calculated by one or both of TX and RX UEs (or machines) 501 and 502.

Beginning with procedure 500A, at 504 and 514, SMCE 503 transmits a pilot signal to each of TX UE 501 and RX UE 502, respectively. The pilot signal can be, e.g., an image signal captured by one of TX UE 501 and RX UE 502 during a video call and shared with SMCE 503. In some implementations, the generation of the pilot signal can involve semantic mirroring and/or semantic augmentation.

At 505 and 515, each of TX UE 501 and RX UE 502 sends a message based on the received pilot signal back to SMCE 503. As discussed above, in some implementations, the pilot signal sent to TX UE 501 at 504 can include un-encoded pilot information, and, in return, the message sent back by TX UE 501 at 505 can be semantically-encoded according to the local KB of TX UE 501. Similarly, the pilot signal sent to RX UE 502 at 514 can included the pilot information semantically encoded according to the global KB of SMCE 503, and, in return, the message sent back by RX UE 502 at 515 can be semantically-decoded according to the local KB of RX UE 502.

SMCE 503 can compare the received messages and calculate SDI based on the difference between the received messages. At 506 and 516, SMCE 503 sends the calculated SDI to each of TX UE 501 and RX UE 502.

The operations in procedure 500A can be periodically performed to keep track of SDI through the semantic communications session. The duration between two consecutive performances of procedure 500A can be configured according to one or more parameters of, e.g., a semantic measurement task or a semantic control task.

Moving to procedure 500B, at 524 and 534, SMCE 503 transmits a pilot signal to each of TX UE 501 and RX UE 502, respectively. The operations at 524 and 534 can be similar to those at 504 and 514.

Upon receiving the pilot signals, TX UE 501 and RX UE 502 make their own calculations of SDI and send the calculated SDI back to SMCE 503 at 525 and 535, respectively. For example, TX UE 501 can decode the pilot signal received at 524 to obtain its version of the pilot information. TX UE 501 can then compare the decoded pilot information with, e.g., reference pilot information, to determine a difference between the two and use the difference to calculate SDI. The SDI thus calculated represents the semantic distortion between SMCE 503 and TX UE 501. Likewise, RX UE 502 can calculate an SDI that represents the semantic distortion between SMCE 503 and RX UE 502.

After receiving the calculated SDIs from TX UE 501 and RX UE 502, SMCE 503 aggregates the two SDIs to obtain an aggregated SDI that represents the semantic distortion between TX UE 501 and RX UE 502. The aggregation can be based on a variety of algorithms, such as an average value, a worst case value, a best case value, and a weighted average value.

At 526 and 536, SMCE 503 sends the aggregated SDI to TX UE 501 and RX UE 502, respectively. As such, both TX UE 501 and RX UE 502 can be informed of the semantic distortion in the semantic communications session between the two UEs.

FIG. 5C illustrates procedure 500C of transmitting pilot signals between TX UE 501, RX UE 502, and SMCE 503, according to some implementations. Procedure 500C include one or more node-Bs (NBs) that provide network service for the signaling between TX UE 501, RX UE 502, and SMCE 503. Procedure 500C can be similar to or supplementary to procedures 500A and/or 500B.

At 541, SMCE 503 transmits a signal to TX UE 501 to trigger procedure 500C for signaling pilots. After receiving the signal, TX UE 501 obtains pilot signal P at 542 and transmits pilot signal P to SMCE 503 at 543. The transmission of pilot signal P can be error protected (e.g., encoded according to an error detection or correction scheme), which can help SMCE 503 track the SDI based on the detected error.

At 544 and 545, each of TX UE 501 and SMCE 503 calculates (e.g., according to a semantic encoding algorithm) a semantic message, S^{TX} and S, respectively, based on pilot signal P. At 546-548, TX UE 501 transmits semantic message S^{TX} to SMCE 503 via a TX NB, which also measures bit errors E(S′^{TX}) in the transmission and transmits E (S′^{TX}) to SMCE 503, with S′^{TX} representing an error-distorted version of S received from TX UE 501.

On the RX side, after calculating semantic message S at 545, SMCE 503 transmits S to RX UE 502 at 549.

At 550 and 551, RX UE 502 measures bit errors E (S′), where S′ represents the error-distorted version of S received from SMCE 503, and reconstructs a message PRY based on S′.

At 552 and 553, RX UE 502 sends P^{RX} and E (P^{RX}) (which can be calculated by an RX NB) to SMCE 503. The transmission of P^{RX} can be error-protected.

At 554, after receiving the calculation and measurement results from TX UE 501 and RX UE 502, SMCE 503 can calculate SDI and perform a root cause analysis. Several examples of root cause analysis are described below.

The above-described SDI calculation can take place in a semantic distortion module in the UEs or in the SMCE. After SDI calculation, the SMCE can initiate a semantic distortion management procedure to reduce semantic distortion and improve QoE and resource efficiency. To this end, the SMCE can perform a root cause analysis based on the comparison of the SDI value with one or more threshold values. For example, the SMCE can compare the SDI value with a first threshold value. If the SDI value is greater than the first threshold value, the SMCE can determine that the semantic communications session suffers from excessive semantic distortion that causes unacceptable QoE. Based on the determination, the SMCE can perform a first root cause analysis for a corrective action that reduces semantic distortion. The first root cause analysis can include one or more parameters to determine, e.g., whether the transmissions suffer from excessive BER, whether the encoder and the decoder involved in the SDI measurements match (e.g., use the same algorithm), or whether the KBs involved in the SDI measurements match (e.g., are all up-to-date and synchronized with each other). The SMCE can take one or more corrective actions based on the first root analysis results. As another example, the SMCE can compare the SDI value with a second threshold value. If the SDI value is less than the second threshold value, the SMCE can determine that it is unnecessary for the semantic communications session to consume resources to achieve such low semantic distortion. Based on the determination, the SMCE can perform a second root cause analysis for an efficiency action that increases resource efficiency. The second root cause analysis can similarly involve one or more parameters.

In some implementations, the parameters for root cause analysis can be input to an artificial intelligence (AI) or machine learning (ML) model. The AL/ML model can be trained to perform the root cause analyses based on the input parameters and adjust semantic and/or networking parameters to achieve desired communications performance. In some implementations, the calculation of SDI are omitted, because the AL/ML model can make semantic and/or networking adjustments directly based on the input parameters.

Although the above description is based on a scenario that the root cause analyses are performed within an SMCE, in some implementations it is possible to distribute the tasks for the root cause analyses among the SMCE and UEs and/or machines involved in the semantic communications session.

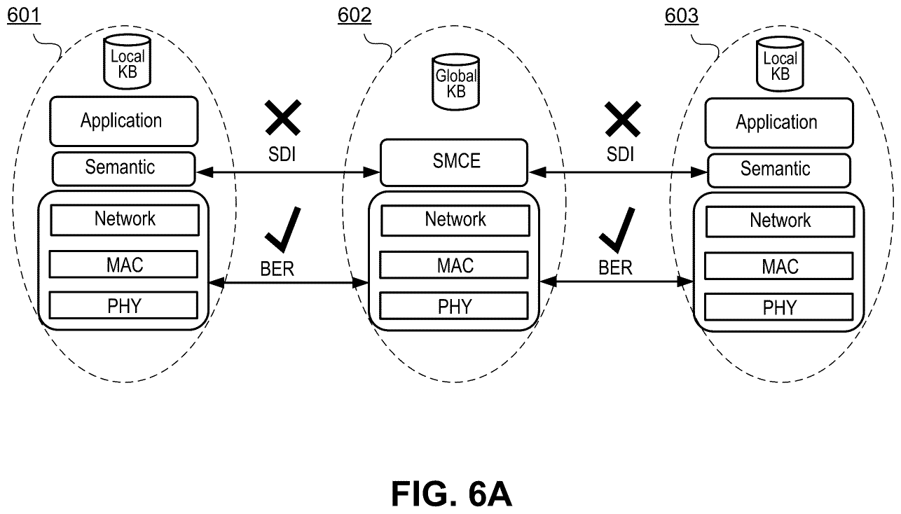

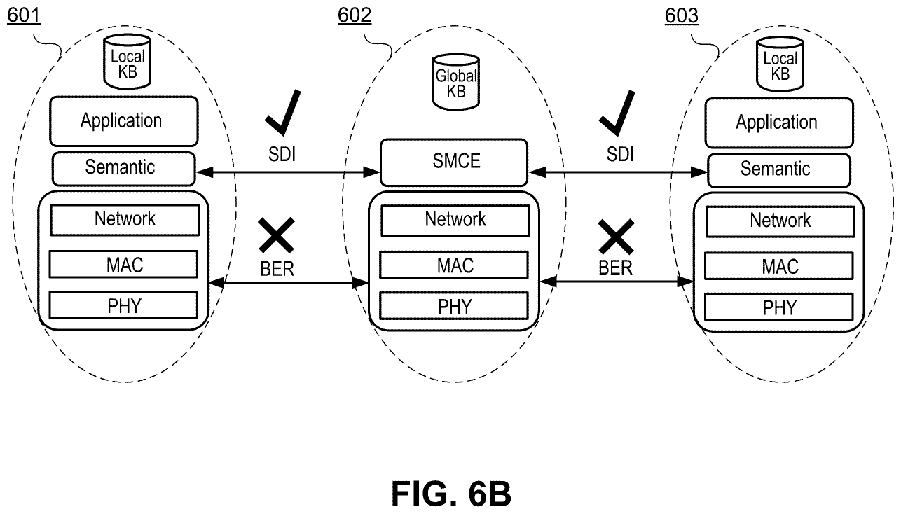

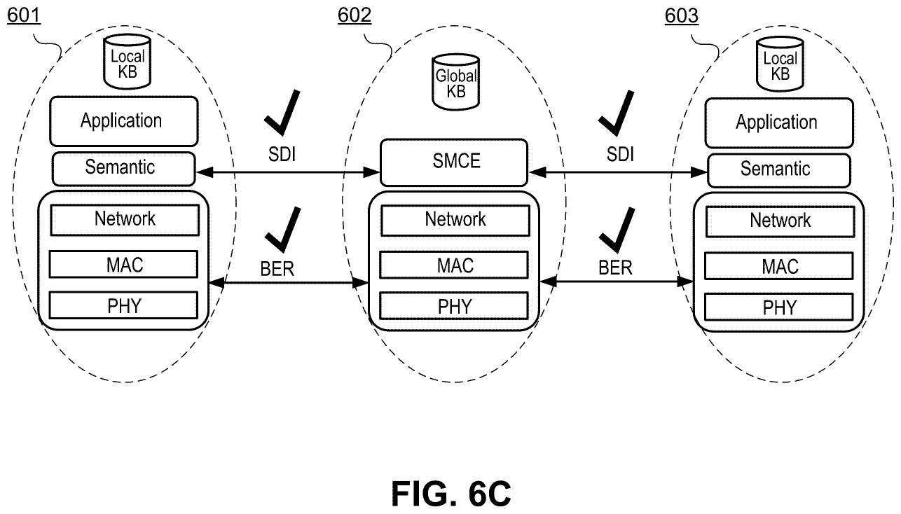

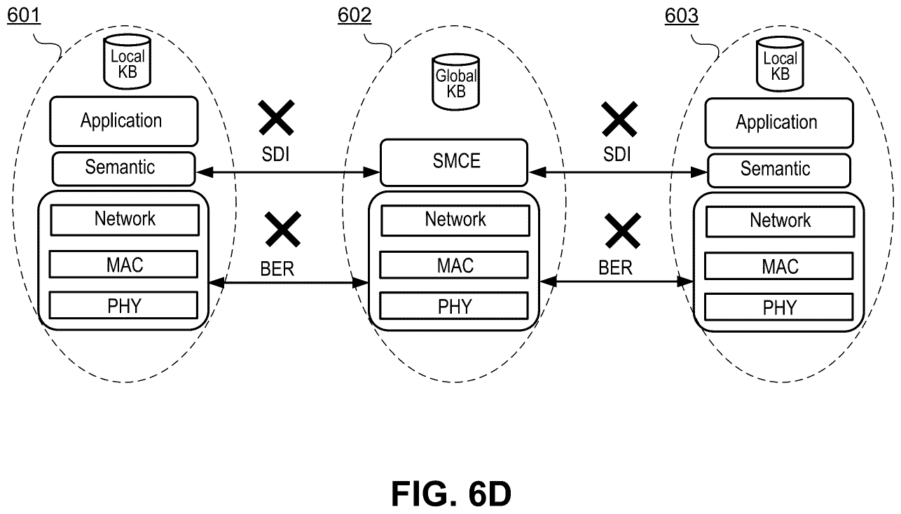

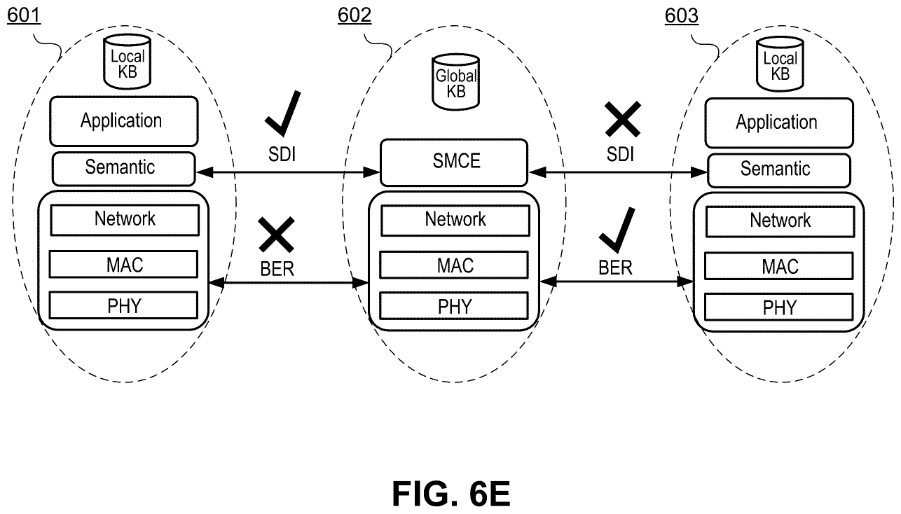

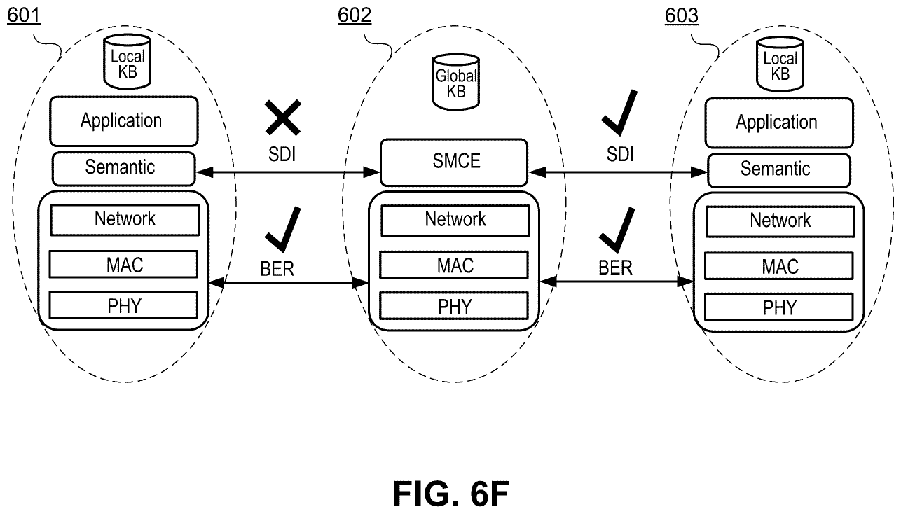

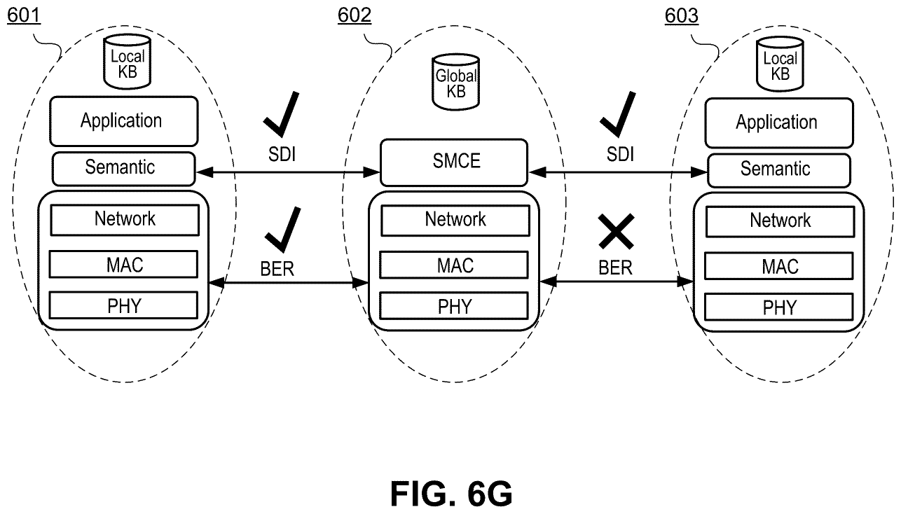

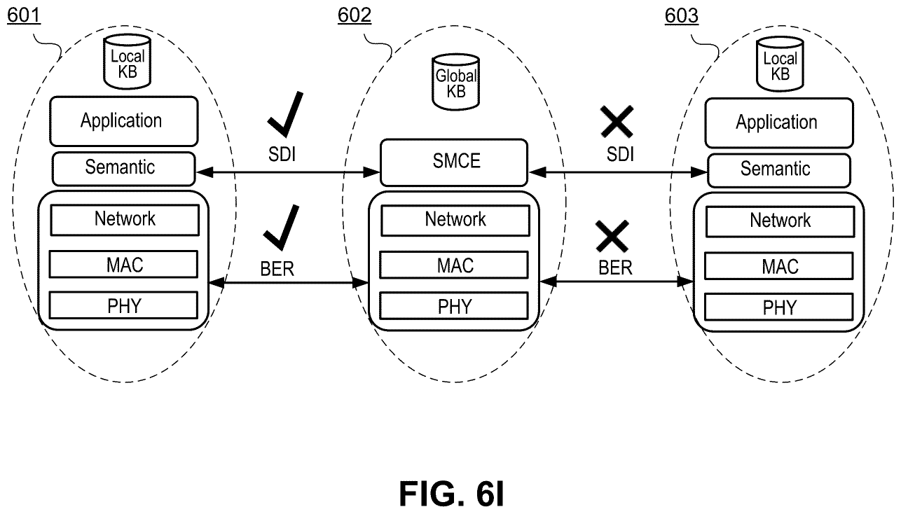

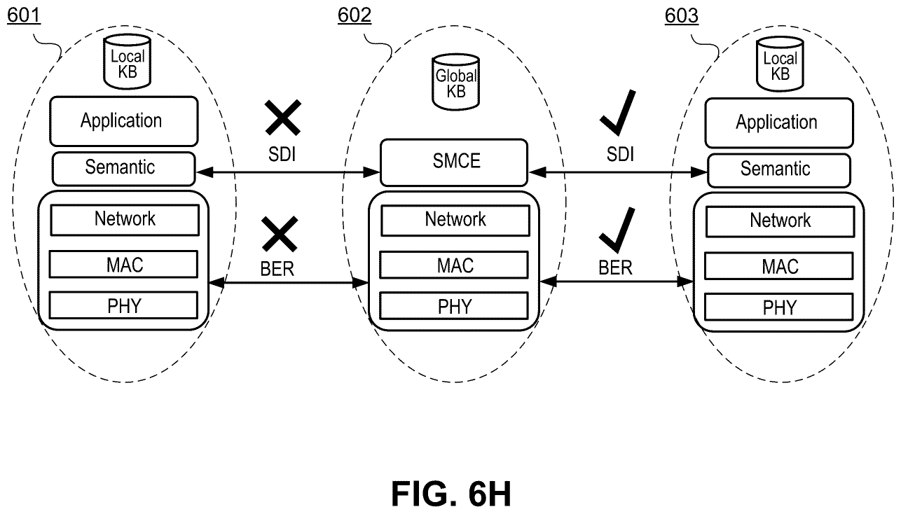

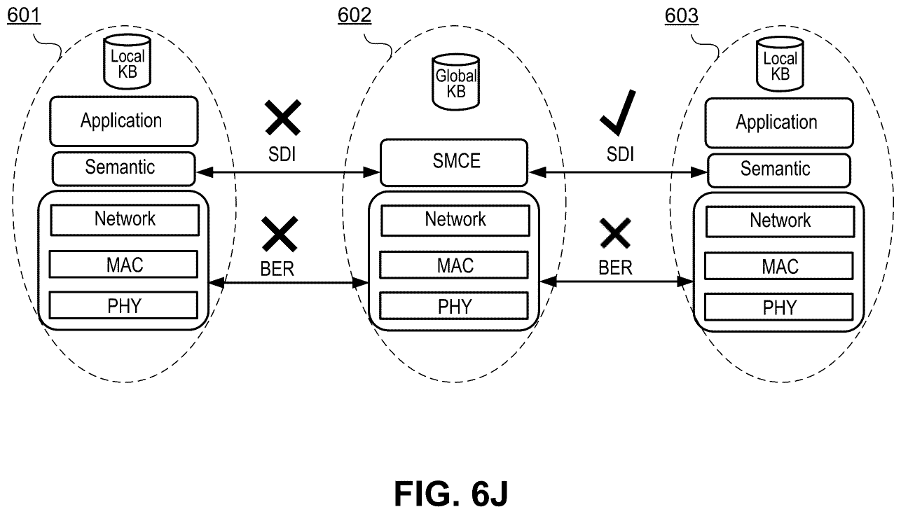

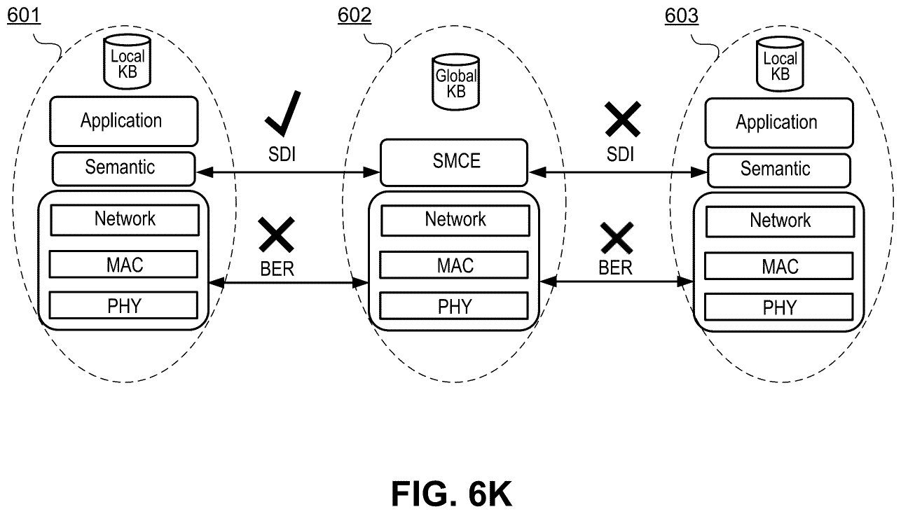

FIGS. 6A-6K each illustrate a scenario of communication quality between TX UE 601, SMCE 602, and RX UE 603 in a communications network, according to some implementations. In each scenario, the communication quality includes traditional communication quality (e.g., end-to-end communication quality at the networking layers) measured by BER and semantic communication quality (e.g., perception quality or semantic task quality at the semantic layer) measured by SDI. Depending on the measured communication quality, the SMCE can determine whether to take a responsive action, such as adjusting one or more parameters. In FIGS. 6A-6K, the symbol √ indicates the communication quality is good (e.g., satisfies a minimum threshold) while the symbol x indicates the communication quality is not good (e.g., does not satisfy a minimum threshold).

In the scenario illustrated in FIG. 6A, the traditional communication quality between SMCE 602 and each of TX UE 601 and RX UE 603 is good, and yet the semantic communication quality between SMCE 602 and each of TX UE 601 and RX UE 603 is not good. In response, SMCE 602 can take one or more following responsive actions. If there are available network resources, SMCE 602 can control TX UE 601 and RX UE 603 to switch to a traditional communications session instead of a semantic communications session. If there are limited (e.g., some but insufficient for a traditional communications session) network resources, SMCE 602 can control TX UE 601 and RX UE 603 to synchronize and update their respective local KBs with a global KB of SMCE 602 to reduce semantic distortion. If there are no available network resources, and if there is a high priority service request, SMCE 602 can control TX UE 601 and RX UE 603 to terminate the semantic communication, e.g., to free up resources for the high-priority task.

In the scenario illustrated in FIG. 6B, the traditional communication quality between SMCE 602 and each of TX UE 601 and RX UE 603 is not good, and yet the semantic communication quality between SMCE 602 and each of TX UE 601 and RX UE 603 is good. In response, SMCE 602 can take one or more following responsive actions. If there are available network resources, SMCE 602 can control TX UE 601 and RX UE 603 to consume more resources to improve the traditional communication quality. If there are limited network resources, SMCE 602 can control TX UE 601 and RX UE 603 to skip or adjust one or more signaling (e.g., modulation and coding scheme [MCS]) or feedback procedures (e.g., HARQ) to improve BER, while allowing the application layer to reconstruct the missing parts of the information due to the skipping or the adjustment.

In the scenario illustrated in FIG. 6C, the traditional communication quality between SMCE 602 and each of TX UE 601 and RX UE 603 is good, and the semantic communication quality between SMCE 602 and each of TX UE 601 and RX UE 603 is good. In response, SMCE 602 can take one or more following responsive actions. If there are no available network resources for upcoming services, SMCE 602 can control TX UE 601 and RX UE 603 to increase compression rate in the semantic communications session (e.g., by conveying more semantic information using fewer bits) and/or in the traditional communications session (e.g., by having higher levels of quadrature amplitude modulation), which reduces the consumed network resources. If there are available network resources for upcoming services, SMCE 602 can control TX UE 601 and RX UE 603 to maintain the current status with no changes to the communications parameters.

In the scenario illustrated in FIG. 6D, the traditional communication quality between SMCE 602 and each of TX UE 601 and RX UE 603 is not good, and the semantic communication quality between SMCE 602 and each of TX UE 601 and RX UE 603 is not good. In response, SMCE 602 can take one or more following responsive actions. If there are available network resources, SMCE 602 can control TX UE 601 and RX UE 603 to initiate the traditional source coding with adaptive error rate correction to improve semantic communication quality on both the TX side and the RX side. If there are no available network resources, SMCE 602 can control TX UE 601 and RX UE 603 to drop the semantic communications session and the traditional communications session in between.

In the scenario illustrated in FIG. 6E, the traditional communication quality between SMCE 602 and TX UE 601 is not good, and yet the traditional communication quality between SMCE 602 and RX UE 603 is good. Additionally, the semantic communication quality between SMCE 602 and TX UE 601 is good, and yet the semantic communication quality between SMCE 602 and RX UE 603 is not good. In response, SMCE 602 can take one or more following responsive actions. Because the traditional communication quality on the TX side is not good, SMCE 602 can attempt to find more resources in the network to improve reliability on the TX side, which can include, e.g., signaling and/or adjusting MSC or feedback procedures (e.g., HARQ), switching to a better channel, or adding transmission diversity. If these actions result in improvement of BER on the TX side and improvement of SDI on the RX side, no further action is performed. Otherwise, SMCE 602 can control TX UE 601 and RX UE 603 to drop the semantic communications session while keeping the traditional communications session when there are available resources.

In the scenario illustrated in FIG. 6F, the traditional communication quality between SMCE 602 and each of TX UE 601 and RX UE 603 is good. Additionally, the semantic communication quality between SMCE 602 and TX UE 601 is good, and yet the semantic communication quality between SMCE 602 and RX UE 603 is not good. In response, SMCE 602 can control TX UE 601 to update its local KB with the global KB of SMCE 602.

In the scenario illustrated in FIG. 6G, the traditional communication quality between SMCE 602 and TX UE 601 is good, and yet the traditional communication quality between SMCE 602 and RX UE 603 is not good. Additionally, the semantic communication quality between SMCE 602 and each of TX UE 601 and RX UE 603 is good. In this case, no BER improvement action is done since the semantic communications session is good enough to communicate information between TX UE 601 and RX UE 603.

In the scenario illustrated in FIG. 6H, the traditional communication quality between SMCE 602 and TX UE 601 is not good, and yet the traditional communication quality between SMCE 602 and RX UE 603 is good. Additionally, the semantic communication quality between SMCE 602 and TX UE 601 is not good, and yet the semantic communication quality between SMCE 602 and RX UE 603 is good. In response, SMCE 602 can control TX UE 601 to update its local KB with the global KB of SMCE 602. No BER improvement action is needed if, after the update, the semantic communications session is good enough to communicate information between TX UE 601 and RX UE 603.

In the scenario illustrated in FIG. 6I, the traditional communication quality between SMCE 602 and TX UE 601 is good, and yet the traditional communication quality between SMCE 602 and RX UE 603 is not good. Additionally, the semantic communication quality between SMCE 602 and TX UE 601 is good, and yet the semantic communication quality between SMCE 602 and RX UE 603 is not good. In response, SMCE 602 can control RX UE 601 to take actions to improve BER, such as the actions described with reference to FIG. 6B. If the BER-improvement actions do not result in improvement in semantic communication quality, SMCE 602 can control RX UE 601 to further update its local KB with the global KB of SMCE 602.

In the scenario illustrated in FIG. 6J, the traditional communication quality between SMCE 602 and TX UE 601 is not good, and the traditional communication quality between SMCE 602 and RX UE 603 is not good. Additionally, the semantic communication quality between SMCE 602 and TX UE 601 is not good, and yet the semantic communication quality between SMCE 602 and RX UE 603 is good. This scenario is less likely to happen in practice than the other illustrated scenarios. In response, SMCE 602 can take BER-improvement actions on both the TX and the RX side, and then control RX UE 601 to update its local KB.

In the scenario illustrated in FIG. 6K, the traditional communication quality between SMCE 602 and each of TX UE 601 and RX UE 603 is not good. Additionally, the semantic communication quality between SMCE 602 and TX UE 601 is good, and yet the semantic communication quality between SMCE 602 and RX UE 603 is not good. In response, SMCE 602 can attempt to find more resources in the network to improve BER on the TX side. If these actions result in improvement of BER on the TX side and improvement of SDI on the RX side, no further action is performed. Otherwise, SMCE 602 can control TX UE 601 and RX UE 603 to drop the semantic communications session while keeping the traditional communications session when there are available resources.

Some semantic communications systems can have multiple SMCEs connected in a mesh node or in a hierarchical mode. These SMCEs can each be associated with one or more UEs or machines and can jointly or separately handle control plan tasks of semantic communications. Each SMCE can separately obtain an SDI based on the UEs or machines coupled to that SMCE, and the semantic communications system can calculate a system-level SDI based on the SDIs individually obtained by each SMCE. The system-level SDI can be determined based on, e.g., an average of all SDIs of individual SMCEs, a maximum of all SDIs of individual SMCEs, or a minimum of all SDIs of individual SMCEs. Alternatively, the SMCEs in the semantic communications system can vote to determine an SDI value as the system-level SDI.

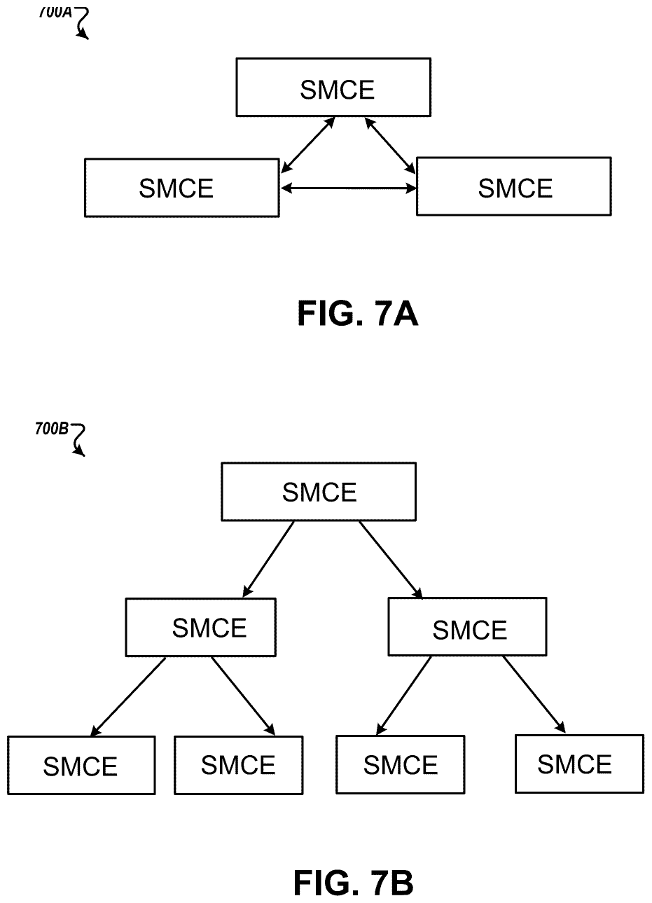

FIGS. 7A and 7B each illustrate an architecture, 700A and 700B, respectively, in which multiple SMCEs are connected, according to some implementations. Architecture 700A is a mesh-mode architecture in which each SMCE establishes communication links with all other neighboring SMCEs. Differently, architecture 700B is a hierarchical-mode architecture with multiple levels, where a higher level SMCE establishes communication links with one or more SMCEs at the level immediately below. A hybrid architecture can be formed to combine a mesh-mode architecture and a hierarchical-mode architecture.

In some implementations, multiple SMCEs in a semantic communications system belong to two or more different operators. For SMCEs belonging to different operators, the global KBs of these SMCE can be operator-specific and can be entirely or partially protected from being accessed from external. Even for SMCEs of the same operator, the SMCEs can belong to different regions or be assigned different location area codes (LACs) depending on the number of users associated with an SMCE. A semantic communications session that involves UEs or machines belonging to the same operator can be referred to as an intra-operator session, and an SMCE managing an intra-operator session can be referred to as an intra-operator SMCE. Conversely, a semantic communications session that involves UEs or machines belonging to the different operators can be referred to as an inter-operator session, and an SMCE managing an inter-operator session can be referred to as an inter-operator SMCE.

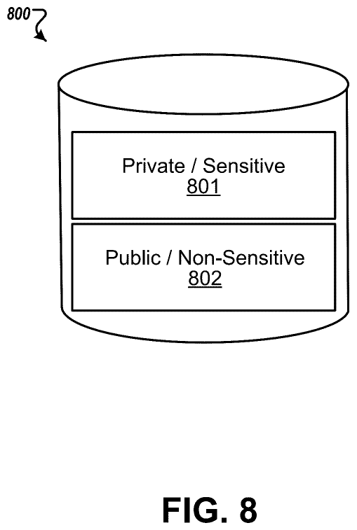

FIG. 8 illustrates partition of data in global KB 800 of an SMCE, according to some implementations. As illustrated, global KB 800 is partitioned into one or more data sections for private and/or sensitive data 801 and one or more data sections for public and/or non-sensitive data 802. Data partitioning in global KB 800 can help improve data privacy and security in multi-SMCE systems, especially when the systems support inter-operator sessions. For example, when a TX UE and an RX UE, which belong to different operators, establish a semantic communications session via associated SMCEs, the TX UE and the RX UE may synchronize their local KBs with the inter-operator SMCEs. To control the synchronization without revealing data that is sensitive to a specific operator or private to a UE, an inter-operator SMCE can allow only its public and/or non-sensitive data 802 to be shared with components that are not affiliated with its operator, while preserving private and/or sensitive data 801. This mechanism can also apply to intra-operator sessions involving SMCEs belong to different areas. For example, a user can request that certain data is to be preserved within an SMCE of a specific area and not shared with SMCEs of other areas. To accommodate the request, the SMCE associated with the user can partition the global KB into multiple sections and determine which sections to share and which to preserve.

Inter-operator SMCEs often have different global KBs with operator-specific information. To reduce semantic distortion in an inter-operator sessions, inter-operator SMCEs can synchronize their global KBs before controlling their associated UEs or machines to respectively update their local KBs. Inter-operator SMCEs can have their global KBs partially or fully synchronized. For a full synchronization, an SMCE can have all partitions of its global KB updated according to the global KB of another SMCE. For a partial synchronization, an SMCE can update only a subset of the partitions, such as only the public and/or non-sensitive sections. Whether adopting partial or full synchronization, the SMCEs involved in the synchronization can use techniques to improve data security, such as anonymization, encryption, differential privacy, and transfer learning algorithms. Similar to the tracking and synchronization of a local KB of a UE or a machine, the synchronization of a global KB of an SMCE can be periodic according to a specific time window or event-based, such as before/after synchronization of a local KB or after finishing a task in failure.

Besides the above-mentioned procedures for tracking and managing semantic distortion and synchronizing KBs, an SMCE can perform semantic trust management, such as retrieving unprocessed data in failed semantic communications sessions, determining outliers and attacks to semantic communications sessions, and ensuring privacy and reliability of semantic communications sessions. The signaling in these procedures can be in-band or out-of-band.

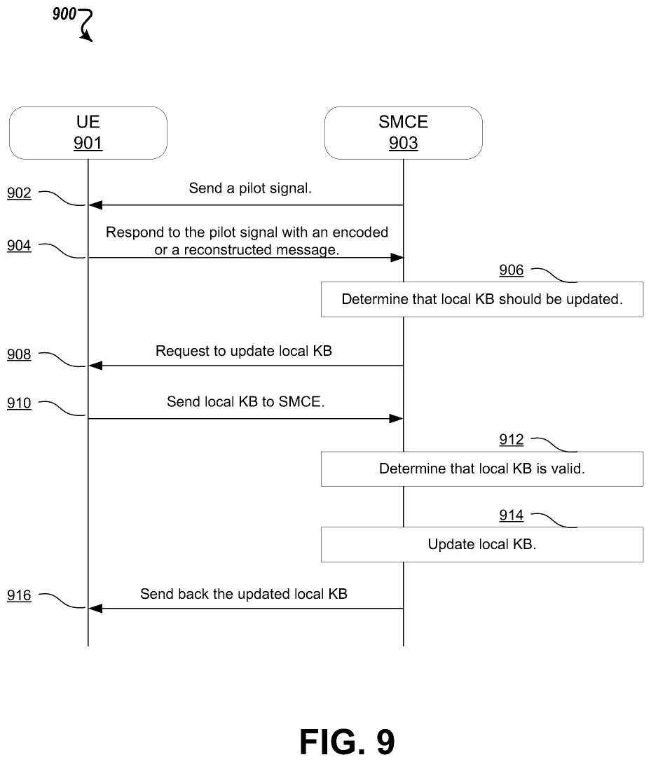

FIG. 9 illustrates procedure 900 for KB synchronization between UE 901 and SMCE 903, according to some implementations. UE 901 and SMCE 903 can be similar to those described above with reference to, e.g., FIGS. 2A-2B, 3, 4A-4B, 5A-5C, and 6A-6K.

At 902, SMCE 903 sends a pilot signal to UE 901. In response, at 904, UE 901 sends an encoded or reconstructed message to SMCE 903. Operations at 902 and 904 can be similar to the operations at 504 and 505 if UE 901 is a TX UE or 514 and 515 if UE 901 is an RX UE.

At 906, SMCE 903 determines that the local KB at UE 901 should be updated. SMCE 903 can make this determination based on a difference between the pilot signal sent at 902 and the response received at 904.

At 908, SMCE 903 requests UE 901 to update the local KB. In response, at 910, UE 901 sends data in its local KB, partially or fully, to SMCE 903. The sharing can be based on a federated learning approach or a transfer learning approach (e.g., certain features that model the data, rather than the exact data itself, is shared). Alternatively or additionally, the sharing can be based on differential privacy where a noisy version of the output of a related data model is shared. If the data has private or sensitive data, UE 901 can send the data encrypted and/or anonymized. However, if UE 901 trusts SMCE 903 (e.g., based on user preference, operator configurations, or update history), then UE 901 can send the private or sensitive data without encryption or anonymization.

At 912, upon receiving the local KB of UE 901, SMCE 903 validates the received local KB. For example, SMCE 903 can determine, based on a predetermined SMCE trustful data model, whether data of the local KB is valid. If SMCE 903 determines that data of the local KB is invalid or suspicious, SMCE 903 can discard the received data and request UE 901 to send its local KB again.

If SMCE 903 determines that data of the local KB is valid, SMCE 903 proceeds to 914 to update the data of the local KB. For example, at 914, SMCE 903 can merge the data received from UE 901 with trustful, up-to-date data stored on SMCE 903. As such, SMCE 903 can obtain an updated version of UE 901's local KB. At 916, SMCE 903 sends the updated local KB back to UE 901.

In some implementations, UEs or machines associated with an SMCE 903 are heterogeneous. Accordingly, the merge at 914 can be different for each TX and RX device according to elements including: context-printed parameters (e.g., privacy, security, and safety), computation and storage-based properties (e.g., small, medium or large data sets), and communication-based properties (e.g., available BW, throughput and delay).

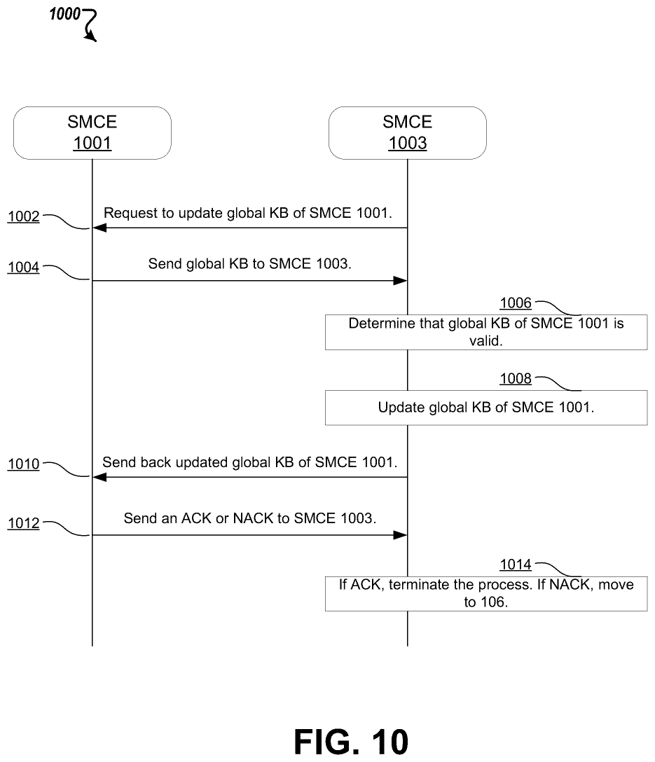

FIG. 10 illustrates procedure 1000 for KB synchronization between SMCE 1001 and SMCE 1003, according to some implementations. SMCEs 1001 and 1003 can be similar to those described above with reference to, e.g., FIGS. 2A-2B, 3, 4A-4B, 5A-5C, and 6A-6K.

At 1002, SMCE 1003 requests SMCE 1001 to update the global KB. In response, at 1004, SMCE 1001 sends data in its global KB, partially or fully, to SMCE 1003. At 1006-1008, SMCE 1003 validates the data of the global KB of SMCE 1001 and, upon determining that data is valid, updates the global KB of SMCE 1001. At 1010, SMCE 1003 sends the updated data back to SMCE 1001. These operations can be similar to operations 908-916 of procedure 900 between SMCE 903 and UE 901.

At 1012, SMCE 1001 sends an ACK or a NACK signal to SMCE 1003 to indicate whether SMCE 1001 has successfully received the updated data and synchronized its global KB using the updated data. At 1014, if SMCE 1003 receives an ACK from SMCE 1001, then SMCE 1003 can deem the synchronization complete and terminate the procedure. Otherwise, if SMCE 1003 receives a NACK from SMCE 1001, then SMCE 1003 can go back to 1006 and repeat the validation and update operations.

Semantic communications can be used in many applications, such as augmented reality (AR), virtual reality (VR), and ultra-reliable low latency communications (URLLC). An example of URLLC application is car platooning.

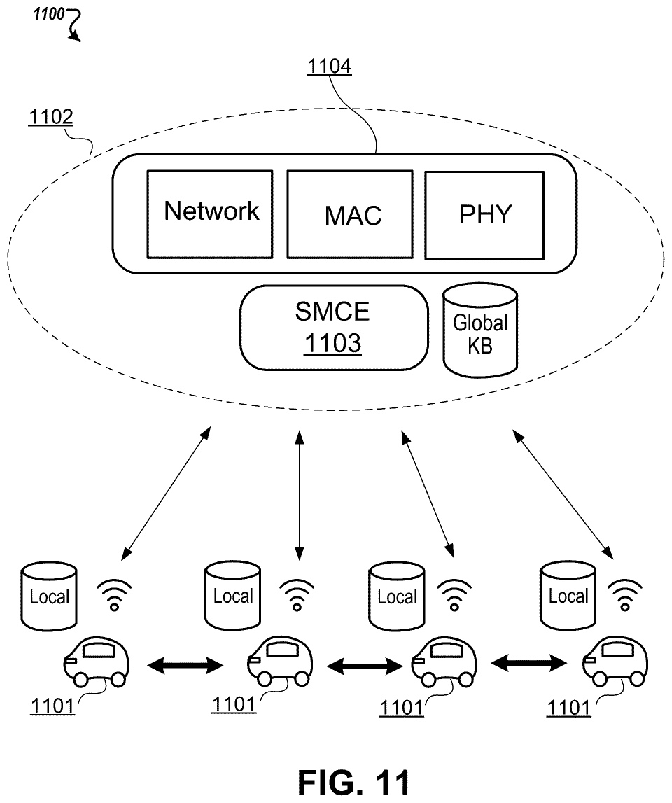

FIG. 11 illustrates a car platooning system 1100 in which autonomous vehicles 1101 communicate with each other and with a control server 1102 in semantic communications sessions, according to some implementations. Server 1102 implements SMCE 1103 associated with a global KB, as well as networking layers 1104. Each of vehicles 1101 has a local KB that can be synchronized with the global KB of SMCE 1103.

When deployed, system 1100 can be configured with one or more control loops. A first control loop can be configured for networking layers 1104 to adjust the time slots for networking parameters, such as CSI. A second loop can be configured within each vehicle 1101 to control the perception of the environment and make driving decisions based on the objectives and states of the fleet. A third loop can be configured for SMCE 1103 to track SDI and, when needed, adjust parameters of the first and second loops (e.g., according to one or more scenarios illustrated in FIGS. 6A-6K). For example, SMCE 1103 can adjust the control time slot of the network and applications based on driving situations, such as reducing the control time slot for highway as compared to low-density rural areas. Alternatively or additionally, SMCE 1103 can enable a redundancy transmission to an edge cloud when the SDI is not good and network resources are available. Alternatively or additionally, SMCE 1103 can disable to semantic communications service when the SDI is not good and no network resources are available. Alternatively or additionally, SMCE 1103 can control networking layers 1104 to discard the HARQ for the MAC layer when the SDI is good and yet the BER is not good.

SMCEs can also be used in AR/VR applications to communicate with AR/VR devices in an AR/VR system. In these applications, the SMCE(s) can be located inside a cloud of a network or embedded in one or more AR/VR devices in a distributed manner.

Similar to the car platooning application, one or more control loops can be configured in the AR/VR system. A first control loop can be configured for the SMCE to adjust networking parameters (e.g., CSI and BER for time slot allocation) and semantic parameters (SDI). A second loop can be configured within each AR/VR device to track and adjust QoE. Also similar to the car platooning application, the SMCE(s) can adjust the network and semantic parameters according to one or more scenarios illustrated in FIGS. 6A-6K.

In some implementations, an RX UE in a semantic communications network can receive, from multiple TX UEs or from multiple transmission paths of a TX UE, semantic messages that convey with the same or related context obtained by different sources. The RX UE can aggregate the semantic messages according to gain and/or multiplexing settings. Such semantic communications are referred to as MU semantic communications. The transmission from each TX UE to the RX UE can be considered a single user semantic communications session. The transmissions from multiple TX UEs to an RX UE can be considered an MU semantic communications session. An SMCE can manage an MU semantic communications session to configure a variety of diversity or multiplexing parameters to achieve a desired performance, such as high communications efficiency and high gains from different sources at the RX UE. More generally, an MU semantic communications session can involve transmitters and receivers with heterogeneous or homogeneous structures for feature detection in human-to-human (e.g., between UEs) communications or machine-to-machine (e.g., task oriented) communications.

For MU scenarios, an SMCE can act as an aggregator among UEs. The SMCE can be a trustful server for UEs in specific applications, which can be hosted by the network from the very edge to the last part of the core. In some implementations, the main functions of an SMCE in the MU scenario include keeping track of end-to-end quality of experience to enhance efficiency and extract the multiplexing and diversity gain in the new area, as described in detail below.

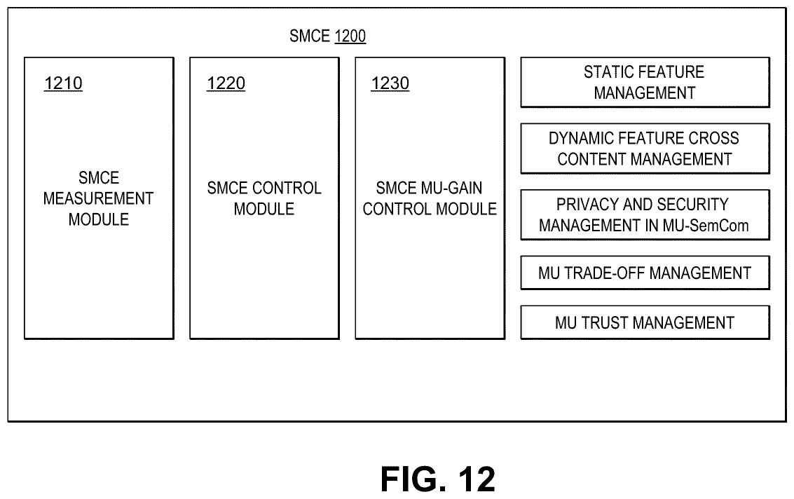

FIG. 12 illustrates control plane modules and tasks of SMCE 1200 that support MU semantic communications, according to some implementations. As illustrated, SMCE 1200 includes semantic measurement module 1210 and semantic control module 1220, which can be similar to semantic measurement module 461 and semantic control module 462, respectively, of FIG. 4B. In addition, SMCE 1200 includes MU-gain control module 1230, which control the MU semantic communications operations and configurations of SMCE 1200. For example, MU-gain control module 1230 can execute one or more control plane tasks for, e.g., static feature management, dynamic feature management, privacy and security management, MU trade-off management, and MU trust management. In some implementations, static features can refer to features that are fixed during one or several sessions, while dynamic features can refer to features that vary at different time slots in a session.

In implementations where a MU semantic communications session is established to convey visual information of an environment (e.g., a scene) from multiple sources to an RX UE, SMCE static feature management can include one or more of: 1) providing a repository for static features of all perceptions of the scene, 2) providing a learning algorithm for devices (e.g., TX UE and RX UE) to learn static features, 3) authentication of the users who can access the static features, 4) controlling the sharing and updating of local KBs of devices, or 5) inquiring and cashing the static features in some of the available users.

SMCE dynamic feature management can include one or more of: 1) controlling real-time communication among contents (e.g., scenes) and users to share information, 2) inquiring dynamic features among users in the same scene with spastic-temporal correlation, or 3) authenticating users' access to the dynamic features.

SMCE privacy and security feature management can include one or more of: 1) detecting anomalies in MU semantic communications, 2) providing an anonymization mechanism when needed, 3) providing end-to-end (E2E) encryption of the session.

SMCE MU trade-off feature management can include one or more of: 1) selecting the number of transmitters, 2) assigning (and n (which respectively represent the number of static and dynamic features that can be assigned to each UE or device) per content for users in a centralized or distributed manner, 3) controlling synchronization in syntactic (e.g., time) and semantic manners (e.g., KBs), or 4) control SDI per session and send and/or generate pilot signals.

SMCE MU trust feature management can include one or more of: 1) keeping track of SDI values of users and comparing with other users, or 2) providing adequate actions to classify users based on their loyalty and trust history.

In some implementations, a MU semantic communications session can improve communication quality perceived by the RX UE, measured by a gain, which can include diversity gain and multiplexing gain. However, the improvement may come with a cost of increased processing power at the TX side. Depending on scenario, the processing power can be approximately modeled as a) a cubic function of the gain, b) a linear function of the gain, or c) independent of the gain. Some measures can be taken to balance the gain and the processing power in MU semantic communications sessions. These measures can include tradeoffs between various parameters, such as number of transmitters (e.g., number of TX UEs or number of TX circuits of the same UE) with the same capabilities and same semantic components, number of transmitters that can send different features to the receivers, static features, model features, processing power modeling, channel gains, and diversity in local KB. These measures consider which of models a)-c) applies to a scenario, and/or the signal-to-noise ratio (SNR) of different regions of the scenario.

For example, for a scenario according to model a) or b), an SMCE can control UEs in a MU semantic communications session to transmit or transfer static features for perceived regions with high or low SNR. This way, transfer gain can be accomplished from sending static features from other devices and/or transferring static features from other contents inside one device, among different devices or devices and clouds.

As another example, for a scenario according to model a) or b) and regardless of SNR, if each transmitter's perception is far less than the size of the environment, an SMCE can increase the number of transmitters that have different areas of focus (AoFs) or different sets of features. The increase of transmission power is insignificant if the channel gains of the TX UEs or transmitters are good. In cases where the channel gains of the TX UEs or transmitters are not good, the SMCE can select the TX UEs or transmitters with the best ratios of transmission power versus computation power.

In some implementations, the time at which the TX UEs perceive the environment is different from a time at which the TX UEs transmit their perceptions to the SMCE. To account for possible environment changes during the time gap, the SMCE can control the TX UEs to share static features of the environment with each other and/or with the RX UE.

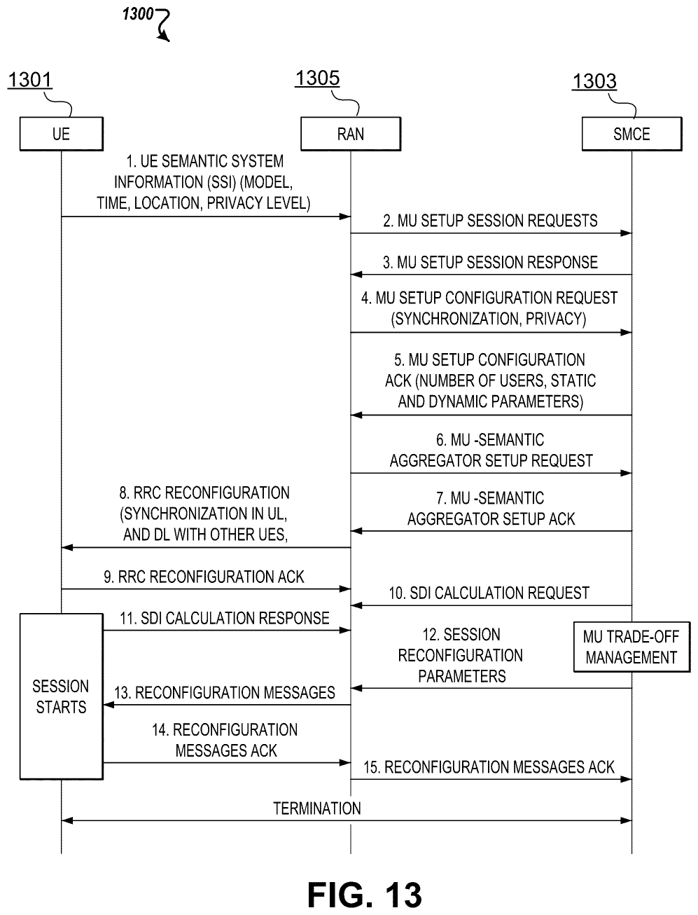

FIG. 13 illustrates procedure 1300 for establishing MU semantic communications, according to some implementations. Procedure 1300 involve UE 1301, SMCE 1303, and radio access network (RAN) 1305, which can be an NB that provides communications service between UE 1301 and SMCE 1303. Other UEs, if present, can follow a similar procedure to establish MU semantic communications.

At 1 and 2, UE 1301 reports semantic system information (SSI) to RAN 1305, which forwards the same to SMCE 1303 to request setup of an MU semantic communications session. The SSI can include, e.g., model capabilities, semantic version, time, location, privacy level, and KB versions of UE 1301.

At 3, SMCE 1303 responds to the setup request received from RAN 1305. Then, at 4-7, SMCE 1303 and RAN 1305 exchange messages to configure the MU semantic communications session and the aggregator. For example, RAN 1305 sends, at 4, an MU setup configuration request with synchronization and privacy information. In return, SMCE 1303 responds, at 5, with an MU setup configuration acknowledgement that indicates, e.g., the number of users in the MU semantic communications session, static parameters, and dynamic parameters. Similarly, SMCE 1303 and RAN 1305 set up an aggregator at 6 and 7 for aggregation of semantic messages from different sources.

At 8 and 9, RAN 1305 provides UE 1301 with radio resource control (RRC) reconfiguration, which can be similar to RRC reconfiguration in traditional communications sessions.

At 10 and 11, the MU semantic communications session starts by SMCE 1303 requesting UE 1301 to provide information for SDI calculation, which can take place at SMCE 1303 or UE 1301. After calculating SDI, SMCE 1303 can perform MU trade-off management to adjust one or more parameters. From 12-15, SMCE 1303 can reconfigure SMCE 1303 with one or more parameters via RAN 1305. After reconfiguration, the setup of the MU semantic communications session can terminate.

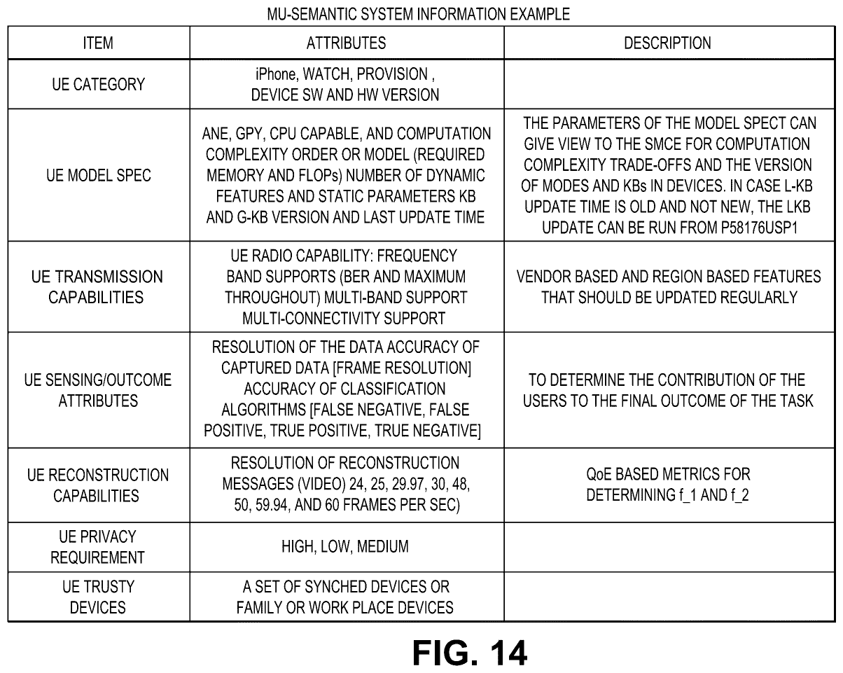

FIG. 14 illustrates example semantic system information elements, according to some implementations. As illustrated, the system information elements can belong to categories including: UE category, UE model specification, UE transmission capabilities, etc. UE 1301, SMCE 1303, and RAN 1305 can use one or more of the illustrated system information elements to set up an MU semantic communications session according to procedure 1300.

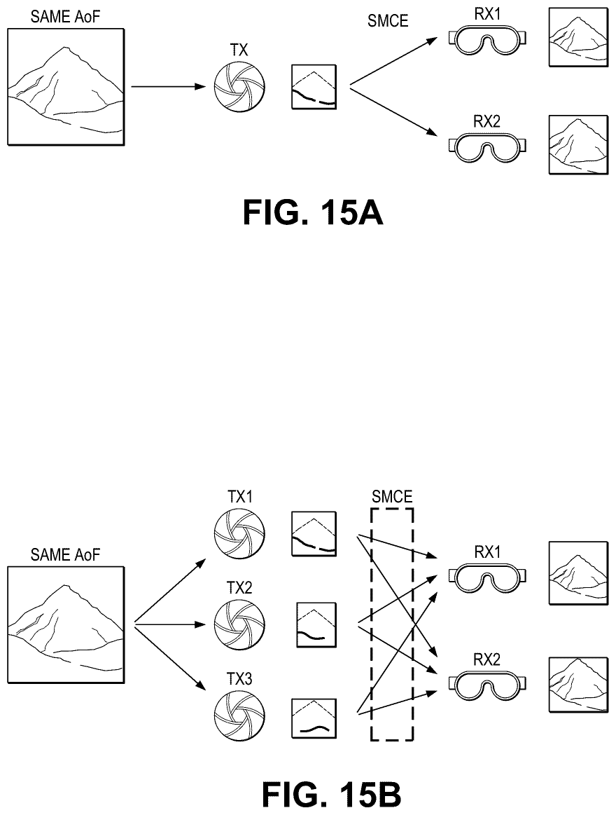

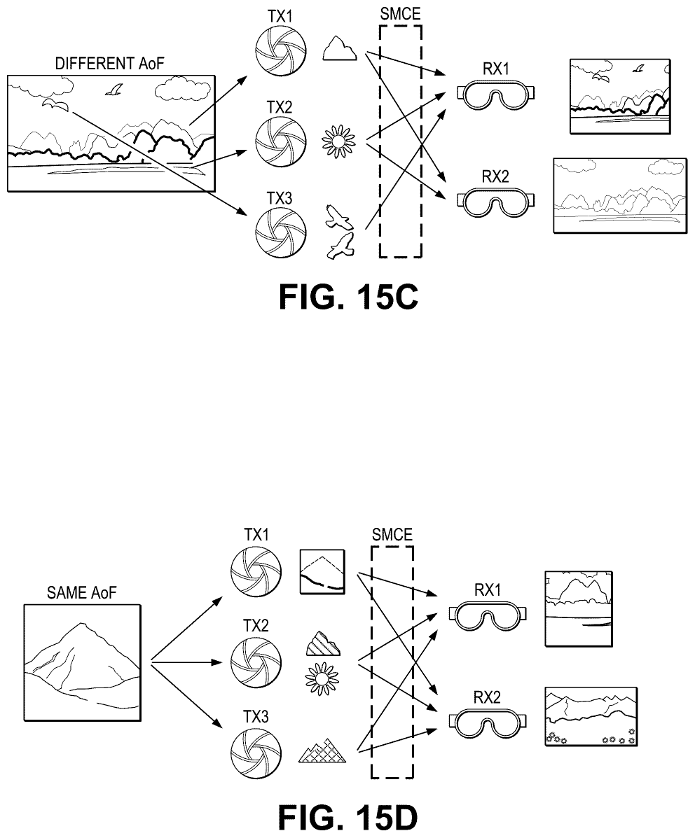

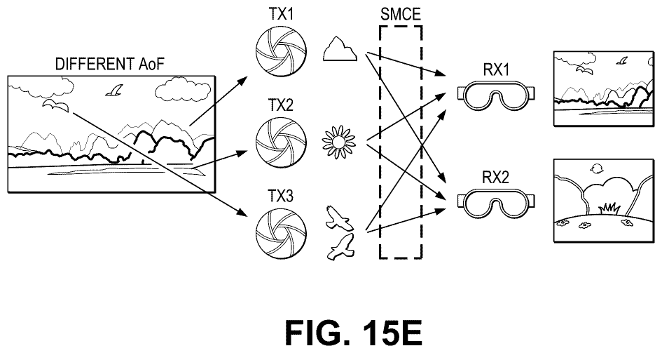

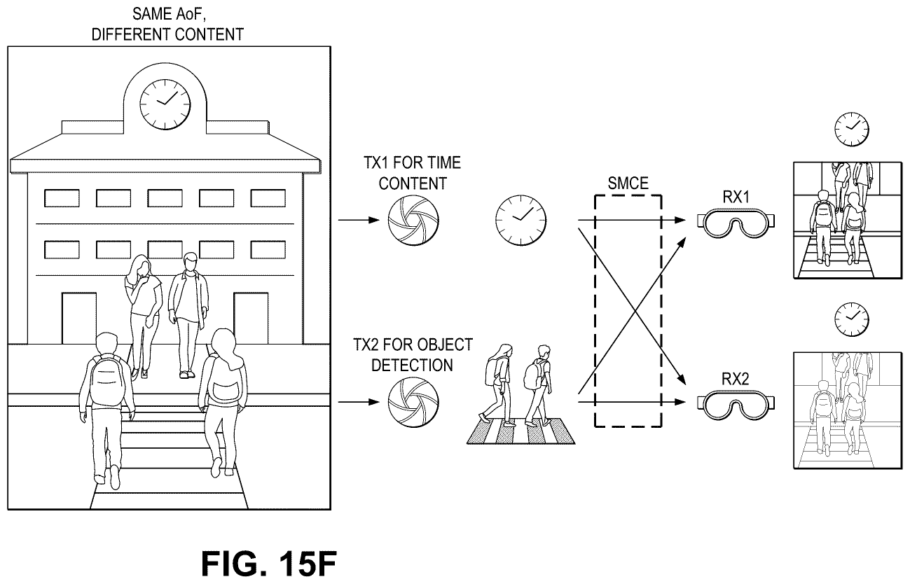

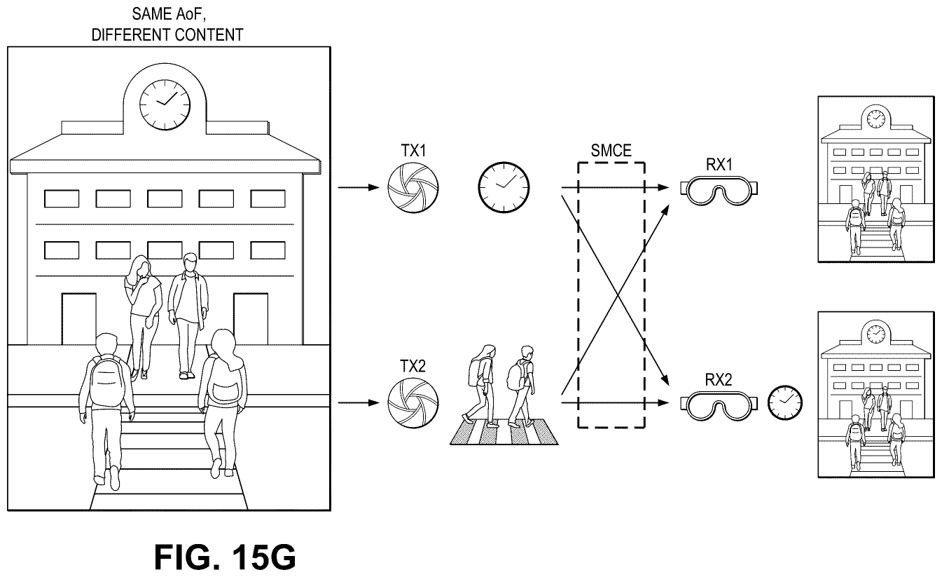

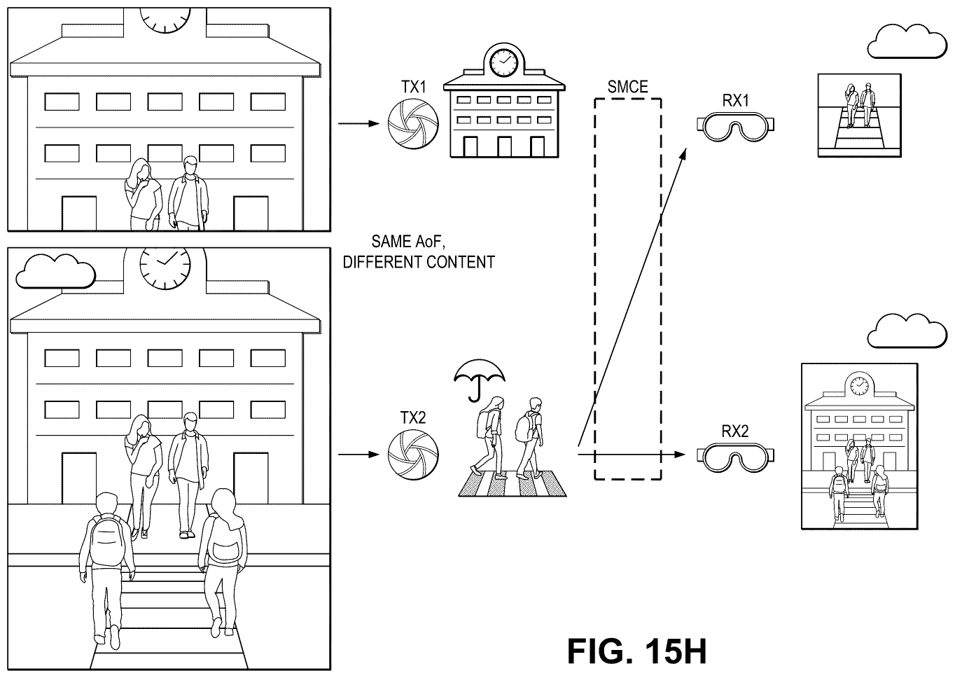

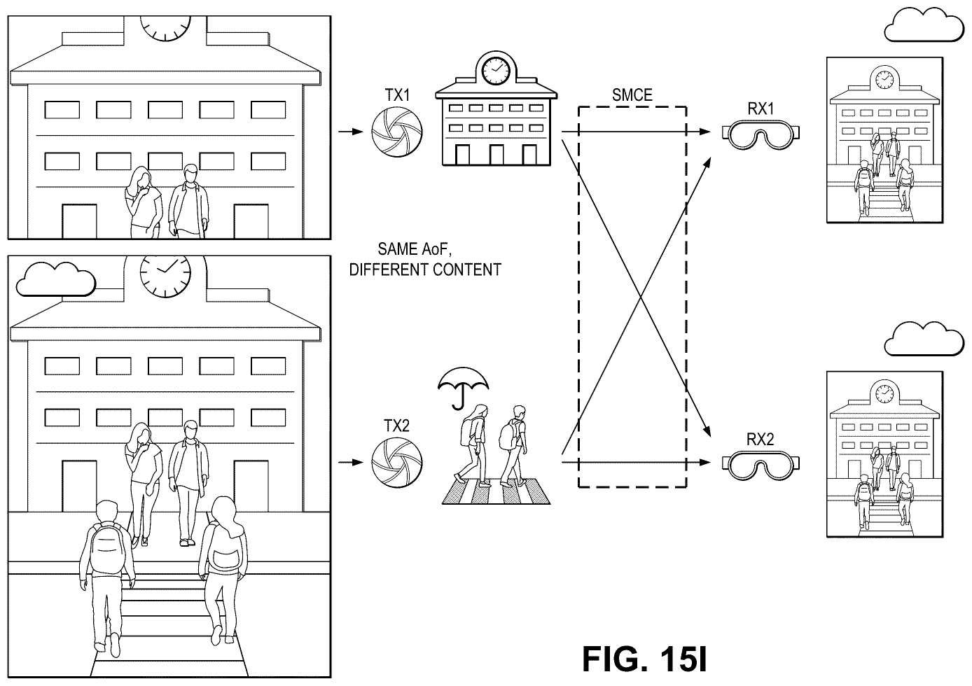

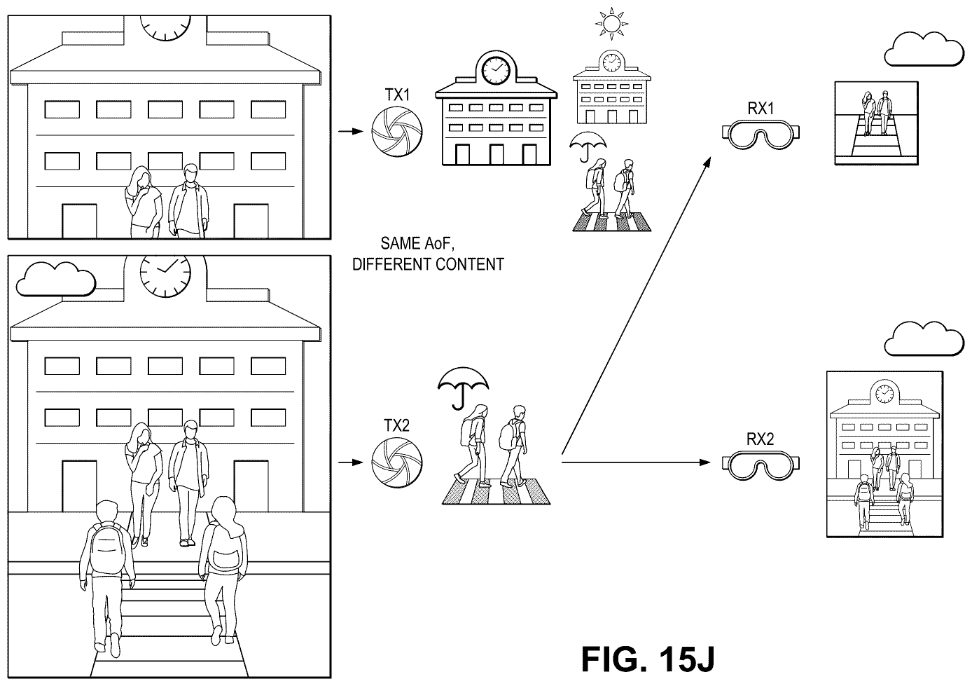

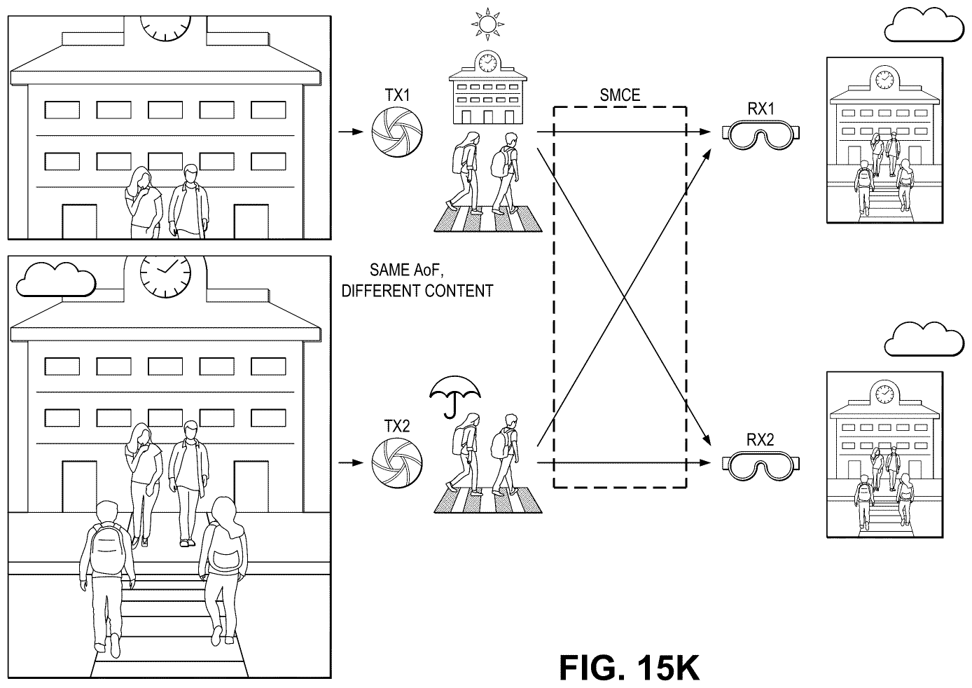

FIGS. 15A-15K illustrate a plurality of example scenarios of reconstructing a message based on semantic communications, according to some implementations.

FIGS. 15A and 15B illustrate scenarios where the TX UE(s) have the same AoF (e.g., angle of perception) to perceive the same environment and the RX UEs have homogenous (e.g., the same or very similar) inference functions (e.g., same local KBs) to reconstruct the received messages. In the scenario of FIG. 15A, a TX UE transmits two semantic messages describing the same environment from the same AoF to two RX UEs, RX1 and RX2. Because the communication channels toward RX1 and RX2 may differ, it is possible that RX1 and RX2 reconstruct different messages. The SMCE can be configured to select the reconstructed message that has better traditional or semantic communications quality to be presented to a user. The diversity gain in this scenario can be similar to that in traditional communications. Because there is no multiplexing at the TX side, there is no multiplexing gain or processing power reduction.

In the scenario of FIG. 15B, three TX UEs, TX1-TX3, each transmit two semantic messages two RX UEs, RX1 and RX2. The three TX UEs have the same AoF of the same environment, and each TX UE transmits very close semantic messages to both RX1 and RX2. For each RX UE, multiplexing gain can possibly be obtained because there are three semantic messages received. As such, the number of transmitters becomes a tradeoff parameter in message reconstruction. For example, the SMCE can select one of the TX1-TX3 with the best channel quality or the lowest SDI for message reconstruction at RX1 and RX2. Alternatively, the SMCE can allow the semantic messages from all of TX1-TX3 to be transmitted to RX1 and RX2, and configure RX1 and RX2 to each reconstruct a message based on a maximum or an average SDI value among the received semantic messages. Alternatively, the SMCE can disable the transmission from one or more TX UEs that have relatively large SDIs, or implement a trust and royalty management procedure to ensure the reconstruction is based on reliable sources.

In the scenarios of FIGS. 15A and 15B, the SMCE's selection of semantic messages from multiple sources can consider the SDIs incurred in the transmissions of these semantic messages. For example, the SMCE can determine an SDI threshold and discard any semantic messages that are received with SDIs higher than the SDI threshold. The SDI threshold can be specified by the SMCE or can be calculated based on, e.g., an average (weighted or federated) of all SDIs of the received semantic messages. Further, scenarios of FIGS. 15A and 15B contemplate multiple semantic messages transmitted from the same TX UE in multiple paths. For example, although three TX UEs are shown in the scenario of FIG. 15B, it is possible that each RX UE receive semantic messages from more than three sources.

FIG. 15C illustrates a scenario where the TX UEs have different AoF to perceive the same environment and the RX UEs have homogenous inference functions to reconstruct the received messages. In the scenario of FIG. 15C, the three TX UEs, TX1-TX3, each perceive a different portion of the environment. Accordingly, the semantic messages transmitted by TX1-TX3 are different, even though the three semantic messages describe the same environment. To properly reconstruct, each RX UE would need to receive the semantic messages transmitted from all TX UEs. In this case, the diversity gain is zero. The multiplexing gains, meanwhile, can be evaluated similar to the multiplexing gains in traditional communications. To balance the multiplexing gains and the processing power consumption, the SMCE can take one or more actions, such as KB synchronization, SDI tracking for missing labels in the transmission, or making tradeoffs among diversity parameters. The tradeoffs can include adjusting parameters such as the number of transmitters, TX sensor settings (e.g., focus, field of view, lighting, etc.), and TX AoF.

FIG. 15D illustrates a scenario where the TX UEs have the same AoF to perceive the same environment and the RX UEs have heterogeneous inference functions (e.g., different local KBs) to reconstruct the received messages. Different from the TX UEs in scenarios of FIGS. 15A and 15B, the TX UEs in the scenario of FIG. 15D has different local KBs, and, accordingly, the semantic messages encoded and transmitted by the TX UEs are different even though the messages are semantically encoded based on the same perceptions. On the RX side, the heterogeneous inference functions can lead to different reconstructed messages. In this scenario, there is no multiplexing gain. However, there can be diversity gains due to the different transmission paths toward each RX UE and due to the different local KBs used by the TX UEs. Accordingly, the SMCE can select messages for reconstruction based on both traditional communication quality (e.g., channel quality) and semantic communication quality (e.g., SDI). The selection can help reduce RX semantic ambiguity due to different local KBs. The selection can also help improve privacy, security, and trust in the transmissions. For example, when the TX UEs are configured to not share their KBs with the SMCE for SDI tracking and semantic synchronization, the SMCE can, through the selection, discard semantic messages from those TX UEs with unacceptably large SDIs.

FIG. 15E illustrates a scenario where the TX UEs have different AoF to perceive the same environment and the RX UEs have heterogeneous inference functions to reconstruct the received messages. The local KBs of the TX UEs may or may not be the same. In this scenario, different semantic messages from the TX UEs can be merged during reconstruction, which can lead to multiplexing gains at each RX UE. The reconstructed messages by RX1 and RX2 can be have similar content but different resolutions due to different channel conditions. In this scenario, besides managing the number of transmitters in a tradeoff between multiplexing gains and processing power, the SMCE can control the TX UEs and RX UEs to track SDI and synchronize local KBs to improve semantic communication quality.

In each of scenarios of FIGS. 15A-15E, because the semantic messages from the TX UEs all convey the same aspect (e.g., objects in a scene) of the same environment, with the same or different AoF, these semantic messages are considered to convey the same content. In scenarios of FIGS. 15F-15K described below, the TX UEs can convey different contents in semantic messages.

FIGS. 15F and 15G each illustrate a scenario where multiple TX UEs having the same AoF transmit semantic messages to convey different contents to multiple RX UEs with homogenous inference functions. As illustrated, the semantic message of TX1 conveys the time perceived from a clock of the scene, while the semantic message of TX1 conveys objects (e.g., crosswalk with pedestrians) perceived at the scene. The SMCE in FIG. 15F is configured to disable cross-content sharing while the SMCE in FIG. 15G is configured to enable cross-content sharing.

In FIG. 15F, the labels (e.g., features of the contents with respect to the scene) of the contents from TX1 and TX2 are not shared at each RX UE during reconstruction. In other words, while RX1 and RX2 each receive the semantic messages from TX1 and TX2, RX1 and RX2 do not have the information that links the perceived time content with the detected object content. There is a chance for having a different reconstruction message due to, e.g., channel attenuation, noise, local KBs, or semantic components. Nevertheless, the richness of message is coming from the capabilities of RX1 and RX2 for reconstruction and the computation complexity per each device is not reduced. Additionally, there is no diversity gain in this scenario.

By contrast, in FIG. 15G, the labels of the contents are shared at each RX UE during reconstruction. Accordingly, each RX UE can reconstruct a message according to both contents. For example, each RX UE can determine that, at a time perceived by TX1, two pedestrians are detected crossing a road on a crosswalk. The merge of contents can lead to multiplexing gains and the reconstructed messages in the scenario of FIG. 15G can be more meaningful that those reconstructed in the scenario of FIG. 15F. To control an MU semantic communications session with cross content, the SMCE can execute control plane tasks that, in addition to track SDI, check and enforce privacy settings at different TX UEs.

Cross-content sharing can include sharing semi-static or static features and sharing dynamic features. An SMCE can implement algorithms to learn these features, and can have a repository to collect semi-static and/or static features and share the features perceived by the TX UEs with the RX UEs based on, e.g., the location information and time correlation information. FIGS. 15H-15I compare scenarios with and without cross-content sharing of semi-static or static features. FIGS. 15J-15K compare scenarios with and without cross-content sharing of dynamic features. In all scenarios of FIGS. 15H-15K, the TX UEs have the same AoF and the RX UEs have homogenous inference functions.

In the scenarios of FIGS. 15H and 15I, the semantic message of TX1 conveys the objects perceived at the scene, while the semantic message of TX1 conveys the weather information (e.g., sunny or rainy) perceived at the scene. In the scenario of FIG. 15H, TX1 does not share its perceived static and semi-static features to the RX UEs. Meanwhile, TX2 only semantically communicates the weather information and pedestrian information in its semantic message. As such, in case the SMCE selects the semantic message from TX2 for reconstruction by RX1 and RX2, the reconstructed messages may miss certain information of the scene. Also, because of channel quality differences, reconstructed messages at RX1 and RX2 can have different resolutions, but the gain cannot be attained through the sharing of the context from users. By contrast, in the scenario of FIG. 15I, static and semi-static features are shared (e.g., transferred) between the TX UEs and the RX UEs, so the reconstructed messages can have more comprehensive information about the objects and the weather at the scene. The shared features can be perceived at the time of transmitting the semantic messages or historically perceived at an earlier time. In both scenarios, there is no diversity gain. In the scenario of FIG. 15I, there can be multiplexing gains.

In the scenarios of FIGS. 15J and 15K, the semantic message of TX1 conveys the objects perceived at the scene, while the semantic message of TX1 conveys the weather information (e.g., sunny or rainy) perceived at the scene. In the scenario of FIG. 15J, TX1 does not share its perceived static and semi-static features to the RX UEs. Accordingly, similar to the scenario of FIG. 15H, due to the limited content conveyed by TX2, it is possible that the reconstructed messages may miss certain information of the scene. By contrast, in the scenario of FIG. 15K, static, semi-static, and dynamic features are shared (at the time of perception or at a different time) between the TX UEs and the RX UEs. This can allow the SMCE to control RX1 and RX2 to use the most recent and accurate information from cross-content sharing to reconstruct the messages. The shared features can be perceived at the time of transmitting the semantic messages or historically perceived at an earlier time. The sharing can have both diversity gains and multiplexing gains.

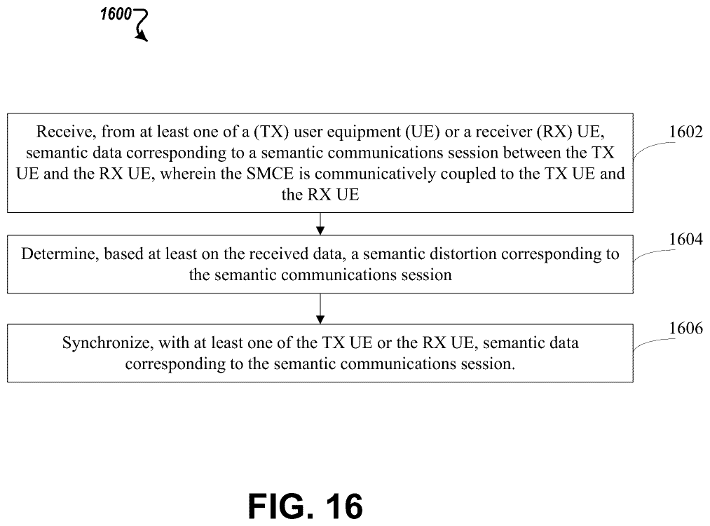

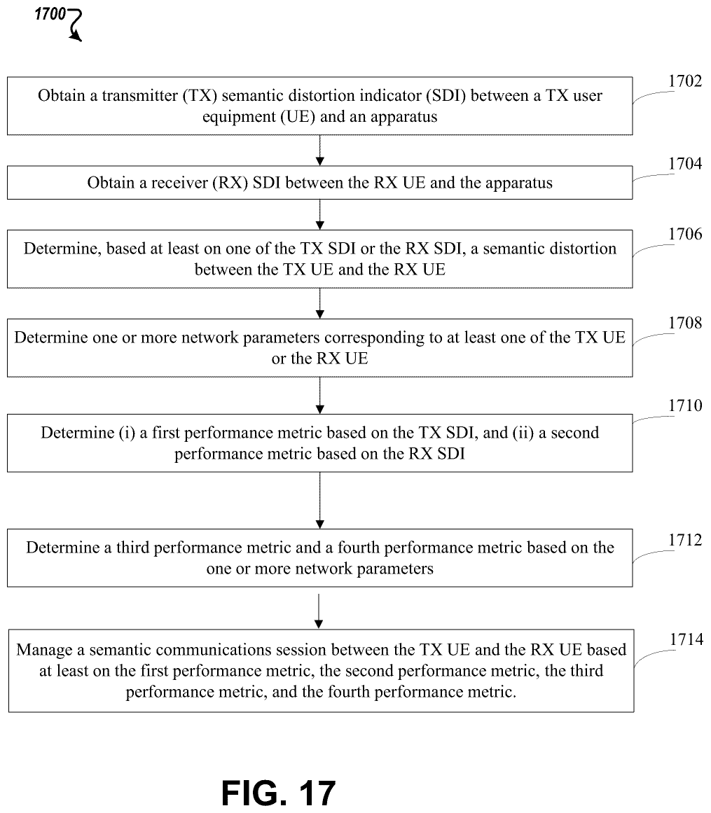

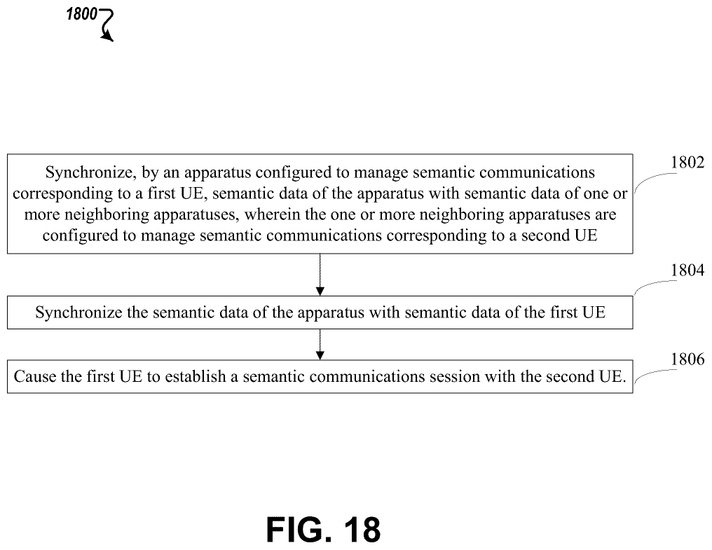

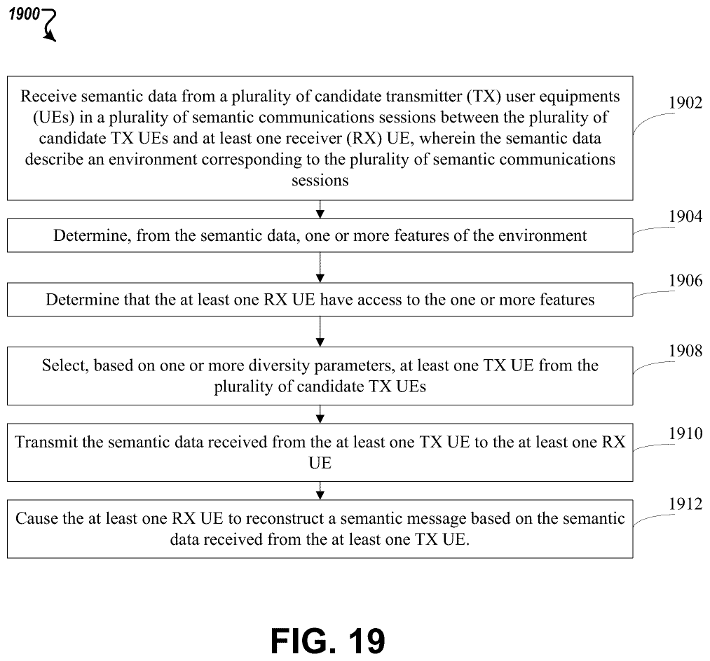

FIG. 16-19 each illustrate a flowchart of an example method, 1600-2000, respectively, according to some implementations. For clarity of presentation, the description that follows generally describes methods 1600-1900 in the context of the other figures in this description. For example, methods 1600-1900 can be performed by an SMCE in any of FIGS. 2A-3. It will be understood that methods 1600-1900 can be performed, for example, by any suitable system, environment, software, hardware, or a combination of systems, environments, software, and hardware, as appropriate. In some implementations, various steps of methods 1600-1900 can be run in parallel, in combination, in loops, or in any order.

Beginning with method 1600, at 1602, the method involves receiving, from at least one of a TX UE or an RX UE, semantic data corresponding to a semantic communications session between the TX UE and the RX UE. The SMCE is communicatively coupled to the TX UE and the RX UE.

At 1604, method 1600 involves determining, based at least on the received data, a semantic distortion corresponding to the semantic communications session.

At 1606, method 1600 involves synchronizing, with at least one of the TX UE or the RX UE, semantic data corresponding to the semantic communications session.

Moving to method 1700, at 1702, the method involves obtaining a TX SDI between a TX UE and an apparatus, which can be an SMCE.

At 1704, method 1700 involves obtaining an RX SDI between the RX UE and the apparatus.

At 1706, method 1700 involves determining, based at least on one of the TX SDI or the RX SDI, a semantic distortion between the TX UE and the RX UE.

At 1708, method 1700 involves determining one or more network parameters corresponding to at least one of the TX UE or the RX UE.

At 1710, method 1700 involves determining (i) a first performance metric based on the TX SDI, and (ii) a second performance metric based on the RX SDI.

At 1712, method 1700 involves determining a third performance metric and a fourth performance metric based on the one or more network parameters.

At 1714, method 1700 involves managing a semantic communications session between the TX UE and the RX UE based at least on the first performance metric, the second performance metric, the third performance metric, and the fourth performance metric.

Moving to method 1800, at 1802, the method involves synchronizing, by an apparatus configured to manage semantic communications corresponding to a first UE, semantic data of the apparatus with semantic data of one or more neighboring apparatuses, wherein the one or more neighboring apparatuses are configured to manage semantic communications corresponding to a second UE.

At 1804, method 1800 involves synchronizing the semantic data of the apparatus with semantic data of the first UE.

At 1806, method 1800 involves causing the first UE to establish a semantic communications session with the second UE.

Moving to method 1900, at 1902, the method involves receiving semantic data from a plurality of candidate TX UEs in a plurality of semantic communications sessions between the plurality of candidate TX UEs and at least one RX UE, wherein the semantic data describe an environment corresponding to the plurality of semantic communications sessions.

At 1904, method 1900 involves determining, from the semantic data, one or more features of the environment.

At 1906, method 1900 involves determining that the at least one RX UE have access to the one or more features.

At 1908, method 1900 involves selecting, based on one or more diversity parameters, at least one TX UE from the plurality of candidate TX UEs.

At 1910, method 1900 involves transmitting the semantic data received from the at least one TX UE to the at least one RX UE.

At 1912, method 1900 involves causing the at least one RX UE to reconstruct a semantic message based on the semantic data received from the at least one TX UE.

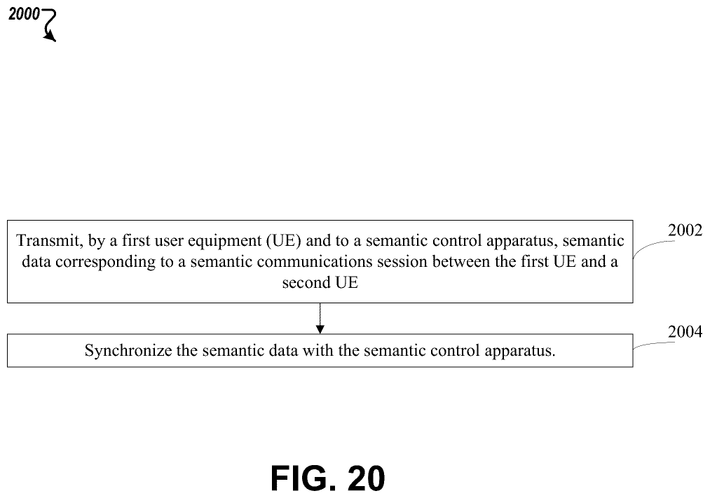

FIG. 20 illustrates a flowchart of an example method 2000, according to some implementations. For clarity of presentation, the description that follows generally describes method 2000 in the context of the other figures in this description. For example, method 2000 can be performed by UE 102 of FIG. 1. It will be understood that method 2000 can be performed, for example, by any suitable system, environment, software, hardware, or a combination of systems, environments, software, and hardware, as appropriate. In some implementations, various steps of method 2000 can be run in parallel, in combination, in loops, or in any order.

At 2002, method 2000 involves transmitting, by a first UE and to a semantic control apparatus, semantic data corresponding to a semantic communications session between the first UE and a second UE.

At 2004, method 2000 involves synchronizing the semantic data with the semantic control apparatus.

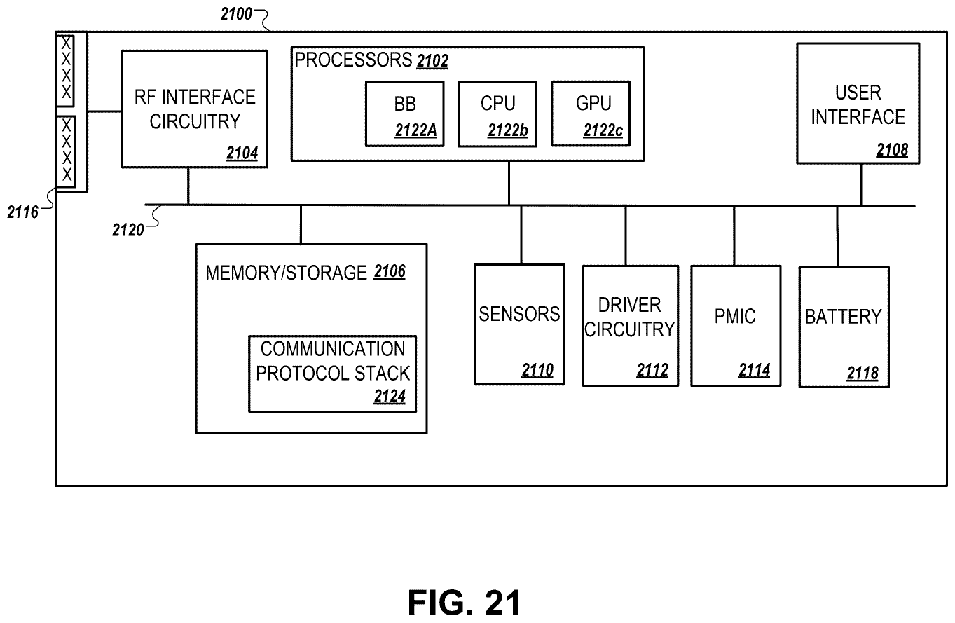

FIG. 21 illustrates an example UE 2100, according to some implementations. The UE 2100 may be similar to and substantially interchangeable with UE 102 of FIG. 1.

The UE 2100 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 2100 may include processors 2102, RF interface circuitry 2104, memory/storage 2106, user interface 2108, sensors 2110, driver circuitry 2112, power management integrated circuit (PMIC) 2114, one or more antenna(s) 2116, and battery 2118. The components of the UE 2100 may be implemented as integrated circuits (ICs), portions thereof, discrete electronic devices, or other modules, logic, hardware, software, firmware, or a combination thereof. The block diagram of FIG. 21 is intended to show a high-level view of some of the components of the UE 2100. However, some of the components shown may be omitted, additional components may be present, and different arrangement of the components shown may occur in other implementations.

The components of the UE 2100 may be coupled with various other components over one or more interconnects 2120, which may represent any type of interface, input/output, bus (local, system, or expansion), transmission line, trace, optical connection, etc. that allows various circuit components (on common or different chips or chipsets) to interact with one another.

The processors 2102 may include processor circuitry such as, for example, baseband processor circuitry (BB) 2122A, central processor unit circuitry (CPU) 2122B, and graphics processor unit circuitry (GPU) 2122C. The processors 2102 may include any type of circuitry or processor circuitry that executes or otherwise operates computer-executable instructions, such as program code, software modules, or functional processes from memory/storage 2106 to cause the UE 2100 to perform operations as described herein.

In some implementations, the baseband processor circuitry 2122A may access a communication protocol stack 2124 in the memory/storage 2106 to communicate over a 3GPP compatible network. In general, the baseband processor circuitry 2122A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 2104. The baseband processor circuitry 2122A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 2106 may include one or more non-transitory, computer-readable media that includes instructions (for example, communication protocol stack 2124) that may be executed by one or more of the processors 2102 to cause the UE 2100 to perform various operations described herein. The memory/storage 2106 include any type of volatile or non-volatile memory that may be distributed throughout the UE 2100. In some implementations, some of the memory/storage 2106 may be located on the processors 2102 themselves (for example, L1 and L2 cache), while other memory/storage 2106 is external to the processors 2102 but accessible thereto via a memory interface. The memory/storage 2106 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2104 may include transceiver circuitry and radio frequency front module (RFEM) that allows the UE 2100 to communicate with other devices over a radio access network. The RF interface circuitry 2104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 2116 and proceed to filter and amplify (with a low-noise amplifier) the signal. The signal may be provided to a receiver of the transceiver that downconverts the RF signal into a baseband signal that is provided to the baseband processor of the processors 2102.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 2116. In various implementations, the RF interface circuitry 2104 may be configured to transmit/receive signals in a manner compatible with NR access technologies.

The antenna(s) 2116 may include one or more antenna elements to convert electrical signals into radio waves to travel through the air and to convert received radio waves into electrical signals. The antenna elements may be arranged into one or more antenna panels. The antenna(s) 2116 may have antenna panels that are omnidirectional, directional, or a combination thereof to enable beamforming and multiple input, multiple output communications. The antenna(s) 2116 may include microstrip antennas, printed antennas fabricated on the surface of one or more printed circuit boards, patch antennas, phased array antennas, etc. The antenna(s) 2116 may have one or more panels designed for specific frequency bands including bands in FR1 or FR2.

The user interface 2108 includes various input/output (I/O) devices designed to enable user interaction with the UE 2100. The user interface 2108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 2100.

The sensors 2110 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2112 may include software and hardware elements that operate to control particular devices that are embedded in the UE 2100, attached to the UE 2100, or otherwise communicatively coupled with the UE 2100. The driver circuitry 2112 may include individual drivers allowing other components to interact with or control various input/output (I/O) devices that may be present within, or connected to, the UE 2100. For example, driver circuitry 2112 may include a display driver to control and allow access to a display device, a touchscreen driver to control and allow access to a touchscreen interface, sensor drivers to obtain sensor readings of sensors 2110 and control and allow access to sensors 2110, drivers to obtain actuator positions of electro-mechanic components or control and allow access to the electro-mechanic components, a camera driver to control and allow access to an embedded image capture device, audio drivers to control and allow access to one or more audio devices.

The PMIC 2114 may manage power provided to various components of the UE 2100. In particular, with respect to the processors 2102, the PMIC 2114 may control power-source selection, voltage scaling, battery charging, or DC-to-DC conversion.

In some implementations, the PMIC 2114 may control, or otherwise be part of, various power saving mechanisms of the UE 2100. A battery 2118 may power the UE 2100, although in some examples the UE 2100 may be mounted deployed in a fixed location, and may have a power supply coupled to an electrical grid. The battery 2118 may be a lithium ion battery, a metal-air battery, such as a zinc-air battery, an aluminum-air battery, a lithium-air battery, and the like. In some implementations, such as in vehicle-based applications, the battery 2118 may be a typical lead-acid automotive battery.

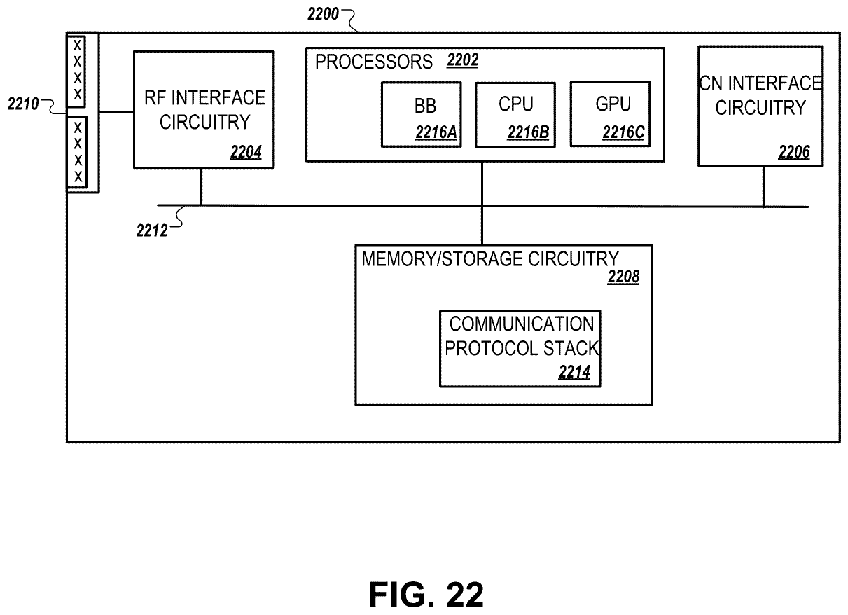

FIG. 22 illustrates an example access node 2200 (e.g., a base station or gNB), according to some implementations. The access node 2200 may be similar to and substantially interchangeable with base station X104. The access node 2200 may include processors 2202, RF interface circuitry 2204, core network (CN) interface circuitry 2206, memory/storage circuitry 2208, and one or more antenna(s) 2210.

The components of the access node 2200 may be coupled with various other components over one or more interconnects 2212. The processors 2202, RF interface circuitry 2204, memory/storage circuitry 2208 (including communication protocol stack 2214), antenna(s) 2210, and interconnects 2212 may be similar to like-named elements shown and described with respect to FIG. 21. For example, the processors 2202 may include processor circuitry such as, for example, baseband processor circuitry (BB) 2216A, central processor unit circuitry (CPU) 2216B, and graphics processor unit circuitry (GPU) 2216C.

The CN interface circuitry 2206 may provide connectivity to a core network, for example, a 5th Generation Core network (5GC) using a 5GC-compatible network interface protocol such as carrier Ethernet protocols, or some other suitable protocol. Network connectivity may be provided to/from the access node 2200 via a fiber optic or wireless backhaul. The CN interface circuitry 2206 may include one or more dedicated processors or FPGAs to communicate using one or more of the aforementioned protocols. In some implementations, the CN interface circuitry 2206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 2200 that operates in an NR or 5G system (for example, a gNB), and the term “E-UTRAN node” or the like may refer to an access node 2200 that operates in an LTE or 4G system (e.g., an eNB). According to various implementations, the access node 2200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 2200 may be implemented as one or more software entities running on server computers as part of a virtual network, which may be referred to as a CRAN and/or a virtual baseband unit pool (vBBUP). In V2X scenarios, the access node 2200 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary implementations are provided.

Example 1 includes a method performed by a Semantic Measurement and Control Entity (SMCE). The method includes: receiving, from at least one of a transmitter (TX) user equipment (UE) or a receiver (RX) UE, semantic data corresponding to a semantic communications session between the TX UE and the RX UE, wherein the SMCE is communicatively coupled to the TX UE and the RX UE; determining, based at least on the received data, a semantic distortion corresponding to the semantic communications session; and synchronizing, with at least one of the TX UE or the RX UE, semantic data corresponding to the semantic communications session.

Example 2 includes the method of example 1, further including: measuring a communication quality between the TX UE and the RX UE, wherein the communication quality comprises at least one of an end-to-end communication quality; and determining a response based at least on the semantic distortion and the communication quality.

Example 3 includes the method of example 2, wherein the response includes information causing an adjustment of one or more parameters corresponding to the semantic communications session.

Example 4 includes the method of example 3, wherein the adjustment is at a network layer or an application layer of at least one of: the TX UE, the RX UE, or a semantic control apparatus.

Example 5 includes the method of example 3, wherein the one or more parameters include a time interval between signal transmissions for at least one of: Channel State Information (CSI), or Hybrid Automatic Repeat Request (HARQ).

Example 6 includes the method of example 3, wherein determining the semantic distortion includes: generating a pilot message including pilot semantic information; encoding the pilot message based on the semantic data to obtain an encoded pilot message; transmitting the pilot message to the TX UE and the encoded pilot message to the RX UE; receiving a TX response message from the TX UE and an RX response message from the RX UE; decoding the TX response message based on the semantic data to obtain a decoded TX response message; and determining a difference between the decoded TX response message and the RX response message.

Example 7 includes the method of example 6, further including transmitting the pilot message and the encoded pilot message periodically, wherein the one or more parameters include a duration between periodic transmissions of the pilot message and the encoded pilot message.

Example 8 includes the method of example 1, wherein determining the semantic distortion includes: determining one or more states of a task corresponding to the semantic communications session; comparing the one or more states of the task with one or more reference stages; and determining a difference between the one or more states and the one or more reference stages.

Example 9 includes the method of example 1, wherein synchronizing the semantic data includes: transmitting an update request to each of the TX UE and the RX UE; receiving TX semantic data from the TX UE and RX semantic data from the RX UE; determining that the TX semantic data and the RX semantic data are valid based at least on a semantic data model; updating the TX semantic data and the RX semantic data based at least on the semantic data model; and transmitting the updated TX semantic data to the TX UE, and transmitting the updated RX semantic data to the RX UE.

Example 10 includes the method of example 9, wherein at least a part of (i) the TX semantic data and (ii) the RX semantic data is received encrypted.

Example 11 includes the method of example 1, further including executing one or more semantic control plane tasks to manage the semantic communications session. Example 12 includes the method of example 11, wherein the one or more semantic control plane tasks include one or more virtual network functions.

Example 13 includes a method including: obtaining a transmitter (TX) semantic distortion indicator (SDI) between a TX user equipment (UE) and an apparatus; obtaining a receiver (RX) SDI between the RX UE and the apparatus; determining, based at least on one of the TX SDI or the RX SDI, a semantic distortion between the TX UE and the RX UE; determining one or more network parameters corresponding to at least one of the TX UE or the RX UE; determining (i) a first performance metric based on the TX SDI, and (ii) a second performance metric based on the RX SDI; determining a third performance metric and a fourth performance metric based on the one or more network parameters; and managing a semantic communications session between the TX UE and the RX UE based at least on the first performance metric, the second performance metric, the third performance metric, and the fourth performance metric.

Example 14 includes the method of example 13, wherein the one or more network parameters include: a TX network parameter that includes a bit error rate measured at the TX UE; and a RX network parameter that includes a bit error rate measured at the RX UE.

Example 15 includes the method of example 13, wherein the determining of adjustments to the semantic communications session is further based on at least one of availability of network resources, or a priority of the communications session.

Example 16 includes the method of example 13, further including: performing a distortion cause analysis in response to determining that at least one of the TX SDI or the RX SDI is greater than a threshold.

Example 16 includes the method of example 13, wherein the first performance metric indicates whether the TX SDI satisfies a first semantic quality threshold, the second performance metric indicates whether the RX SDI satisfies a second semantic quality threshold, the third performance metric indicates whether the TX error rate satisfies a third quality threshold, and the fourth performance metric indicates whether the RX error rate satisfies a fourth quality threshold.

Example 18 includes a method including: synchronizing, by an apparatus configured to manage semantic communications corresponding to a first user equipment (UE), semantic data of the apparatus with semantic data of one or more neighboring apparatuses, wherein the one or more neighboring apparatuses are configured to manage semantic communications corresponding to a second UE; synchronizing the semantic data of the apparatus with semantic data of the first UE; and causing the first UE to establish a semantic communications session with the second UE.

Example 19 includes the method of example 18, wherein synchronizing the semantic data of the apparatus with the semantic data of the one or more neighboring apparatuses includes: receiving an update request from the one or more neighboring apparatuses; transmitting at least a part of the semantic data of the apparatus to the one or more neighboring apparatuses; receiving updated semantic data from the one or more neighboring apparatuses; and transmitting a feedback signal to the one or more neighboring apparatuses.

Example 20 includes the method of example 18, wherein the one or more neighboring apparatuses and the apparatus belong to different network operators.

Example 21 includes the method of example 1, further including calculating a first semantic distortion of the first UE in the semantic communications session.

Example 22 includes the method of example 21, further including: receiving a second semantic distortion of the second UE in the semantic communications session, the second semantic distortion being determined by the one or more neighboring apparatuses; and calculating a system semantic distortion based on an average value of the first semantic distortion and the second semantic distortion.

Example 23 includes the method of example 18, further including: receiving a second semantic distortion of the second UE in the semantic communications session, the second semantic distortion being determined by the one or more neighboring apparatuses; and calculating a system semantic distortion based on a largest value among the first semantic distortion and the second semantic distortion.

Example 24 includes the method of example 18, further including: receiving a second semantic distortion of the second UE in the semantic communications session, the second semantic distortion being determined by the one or more neighboring apparatuses; and calculating a system semantic distortion based on a least value among the first semantic distortion and the second semantic distortion.

Example 25 includes the method of example 18, further including: receiving a second semantic distortion of the second UE in the semantic communications session, the second semantic distortion being determined by the one or more neighboring apparatuses; and calculating a system semantic distortion based on a value collectively determined by the apparatus and the one or more neighboring apparatuses.

Example 26 includes the method of example 18, wherein the apparatus and the one or more neighboring apparatuses have different location area codes.

Example 27 includes a method including: receiving semantic data from a plurality of candidate transmitter (TX) user equipments (UEs) in a plurality of semantic communications sessions between the plurality of candidate TX UEs and at least one receiver (RX) UE, wherein the semantic data describe an environment corresponding to the plurality of semantic communications sessions; determining, from the semantic data, one or more features of the environment; determining that the at least one RX UE have access to the one or more features; selecting, based on one or more diversity or multiplexing parameters, at least one TX UE from the plurality of candidate TX UEs; transmitting the semantic data received from the at least one TX UE to the at least one RX UE; and causing the at least one RX UE to reconstruct a semantic message based on the semantic data received from the at least one TX UE.

Example 28 includes the method of example 27, wherein transmitting the semantic message includes transmitting the one or more features.

Example 29 includes the method of example 27, wherein the one or more features include at least one of: a static feature, or a dynamic feature.

Example 30 includes the method of example 27, wherein the one or more features include at least one feature obtained earlier than the plurality of semantic communications sessions.

Example 31 includes the method of example 27, wherein the one or more diversity or multiplexing parameters include at least one of: a number of the at least one TX UE, semantic distortions of the plurality of semantic communications sessions, sensor configurations of the plurality of candidate TX UEs, one or more static features, or channel gains of the plurality of semantic communications sessions.

Example 32 includes a method including: transmitting, by a first user equipment (UE) and to a semantic control apparatus, semantic data corresponding to a semantic communications session between the first UE and a second UE; synchronizing the semantic data with the semantic control apparatus.

Example 33 includes the method of example 33, further including determining a semantic distortion indicator (SDI) between the first UE and the semantic control apparatus.

Example 34 includes the method of example 33, further including adjusting one or more parameters at a network layer or an application layer of the first UE.

Example 35 includes the method of example 33, further including executing one or more semantic control plane tasks to manage the semantic communications session.

Example 36 includes the method of example 33, wherein the semantic control apparatus is a first semantic control apparatus, the method further including: causing the first semantic control apparatus to synchronize the semantic data with a second semantic control apparatus; and establishing the semantic communications session with the second UE through the first semantic control apparatus and the second semantic control apparatus.

Example 37 includes an apparatus including one or more processors configured to perform the method of any of examples 1-31.

Example 38 includes a UE including one or more processors configured to perform the method of any of examples 32-36.

Example 39 may include one or more non-transitory computer-readable media including instructions to cause an electronic device, upon execution of the instructions by one or more processors of the electronic device, to perform one or more elements of a method described in or related to any of examples 1-36, or any other method or process described herein.

Example 40 may include an apparatus including logic, modules, or circuitry to perform one or more elements of a method described in or related to any of examples 1-36, or any other method or process described herein.

Example 41 may include a method, technique, or process as described in or related to any of examples 1-36, or portions or parts thereof.

Example 42 may include an apparatus including: one or more processors and one or more computer-readable media including instructions that, when executed by the one or more processors, cause the one or more processors to perform the method, techniques, or process as described in or related to any of examples 1-36, or portions thereof.

Example 43 may include a signal as described in or related to any of examples 1-36, or portions or parts thereof.

Example 44 may include a datagram, information element, packet, frame, segment, PDU, or message as described in or related to any of examples 1-36, or portions or parts thereof, or otherwise described in the present disclosure.

Example 45 may include a signal encoded with data as described in or related to any of examples 1-36, or portions or parts thereof, or otherwise described in the present disclosure.

Example 46 may include a signal encoded with a datagram, IE, packet, frame, segment, PDU, or message as described in or related to any of examples 1-36, or portions or parts thereof, or otherwise described in the present disclosure.

Example 47 may include an electromagnetic signal carrying computer-readable instructions, wherein execution of the computer-readable instructions by one or more processors is to cause the one or more processors to perform the method, techniques, or process as described in or related to any of examples 1-36, or portions thereof.

Example 48 may include a computer program including instructions, wherein execution of the program by a processing element is to cause the processing element to carry out the method, techniques, or process as described in or related to any of examples 1-36, or portions thereof. The operations or actions performed by the instructions executed by the processing element can include the methods of any one of examples 1-36.

Example 49 may include a signal in a wireless network as shown and described herein.

Example 50 may include a method of communicating in a wireless network as shown and described herein.

Example 51 may include a system for providing wireless communications as shown and described herein. The operations or actions performed by the system can include the methods of any one of examples 1-36.

Example 52 may include a device for providing wireless communications as shown and described herein. The operations or actions performed by the device can include the methods of any one of examples 1-36.

The previously-described examples 1-36 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The operations or actions performed either by the system or by the instructions executed by data processing apparatus can include the methods of any one of examples 1-36.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method performed by a Semantic Measurement and Control Entity (SMCE), the method comprising:
receiving, from at least one of a transmitter (TX) user equipment (UE) or a receiver (RX) UE, semantic data corresponding to a semantic communications session between the TX UE and the RX UE, wherein the SMCE is communicatively coupled to the TX UE and the RX UE;
determining, based at least on the received data, a semantic distortion corresponding to the semantic communications session; and
synchronizing, with at least one of the TX UE or the RX UE, semantic data corresponding to the semantic communications session.

2. The method of claim 1, further comprising:
measuring a communication quality between the TX UE and the RX UE, wherein the communication quality comprises at least one of an end-to-end communication quality, a perception quality, or a task quality; and
determining a response based at least on the semantic distortion and the communication quality.

3. The method of claim 2, wherein the response comprises information causing an adjustment of one or more parameters corresponding to the semantic communications session.

4. The method of claim 3, wherein the adjustment is at a network layer or an application layer of at least one of:
the TX UE,
the RX UE, or
a semantic control apparatus.

5. The method of claim 3, wherein the one or more parameters comprise a time interval between signal transmissions for at least one of:
Channel State Information (CSI), or
Hybrid Automatic Repeat Request (HARQ).

6. The method of claim 3, wherein determining the semantic distortion comprises:
generating a pilot message comprising pilot semantic information;
encoding the pilot message based on the semantic data to obtain an encoded pilot message;
transmitting the pilot message to the TX UE and the encoded pilot message to the RX UE;
receiving a TX response message from the TX UE and an RX response message from the RX UE;
decoding the TX response message based on the semantic data to obtain a decoded TX response message; and
determining a difference between the decoded TX response message and the RX response message.

7. The method of claim 6, further comprising transmitting the pilot message and the encoded pilot message periodically, wherein the one or more parameters comprise a duration between periodic transmissions of the pilot message and the encoded pilot message.

8. The method of claim 1, wherein determining the semantic distortion comprises:
determining one or more states of a task corresponding to the semantic communications session;
comparing the one or more states of the task with one or more reference stages; and
determining a difference between the one or more states and the one or more reference stages.

9. The method of claim 1, wherein synchronizing the semantic data comprises:
transmitting an update request to each of the TX UE and the RX UE;
receiving TX semantic data from the TX UE and RX semantic data from the RX UE;
determining that the TX semantic data and the RX semantic data are valid based at least on a semantic data model;
updating the TX semantic data and the RX semantic data based at least on the semantic data model; and
transmitting the updated TX semantic data to the TX UE, and transmitting the updated RX semantic data to the RX UE.

10. The method of claim 9, wherein at least a part of (i) the TX semantic data and (ii) the RX semantic data is received encrypted.

11. The method of claim 1, further comprising executing one or more semantic control plane tasks to manage the semantic communications session.

12. The method of claim 11, wherein the one or more semantic control plane tasks comprise one or more virtual network functions.

13-38. (canceled)

39. An apparatus comprising one or more processors configured to perform operations comprising:
receiving, from at least one of a transmitter (TX) user equipment (UE) or a receiver (RX) UE, semantic data corresponding to a semantic communications session between the TX UE and the RX UE, wherein a Semantic Measurement and Control Entity (SMCE) is communicatively coupled to the TX UE and the RX UE;
determining, based at least on the received data, a semantic distortion corresponding to the semantic communications session; and
synchronizing, with at least one of the TX UE or the RX UE, semantic data corresponding to the semantic communications session.

40. The apparatus of claim 39, the operations further comprising:
measuring a communication quality between the TX UE and the RX UE, wherein the communication quality comprises at least one of an end-to-end communication quality, a perception quality, or a task quality; and
determining a response based at least on the semantic distortion and the communication quality.

41. The apparatus of claim 40, wherein the response comprises information causing an adjustment of one or more parameters corresponding to the semantic communications session, and
wherein the adjustment is at a network layer or an application layer of at least one of:
the TX UE,
the RX UE, or
a semantic control apparatus, and
wherein the one or more parameters comprise a time interval between signal transmissions for at least one of:
Channel State Information (CSI), or
Hybrid Automatic Repeat Request (HARQ).

42. The apparatus of claim 41, wherein determining the semantic distortion comprises:
generating a pilot message comprising pilot semantic information;
encoding the pilot message based on the semantic data to obtain an encoded pilot message;
transmitting the pilot message to the TX UE and the encoded pilot message to the RX UE;
receiving a TX response message from the TX UE and an RX response message from the RX UE;
decoding the TX response message based on the semantic data to obtain a decoded TX response message; and
determining a difference between the decoded TX response message and the RX response message.

43. The apparatus of claim 42, the operations further comprising transmitting the pilot message and the encoded pilot message periodically, wherein the one or more parameters comprise a duration between periodic transmissions of the pilot message and the encoded pilot message.

44. The apparatus of claim 39, wherein determining the semantic distortion comprises:
determining one or more states of a task corresponding to the semantic communications session;
comparing the one or more states of the task with one or more reference stages; and
determining a difference between the one or more states and the one or more reference stages.

45. The apparatus of claim 39, wherein synchronizing the semantic data comprises:
transmitting an update request to each of the TX UE and the RX UE;
receiving TX semantic data from the TX UE and RX semantic data from the RX UE;
determining that the TX semantic data and the RX semantic data are valid based at least on a semantic data model;
updating the TX semantic data and the RX semantic data based at least on the semantic data model; and
transmitting the updated TX semantic data to the TX UE, and transmitting the updated RX semantic data to the RX UE.

46. A user equipment (UE) comprising one or more processors configured to perform operations comprising:
receiving, from at least one of a transmitter (TX) UE or a receiver UE, semantic data corresponding to a semantic communications session between the TX UE and the RX UE, wherein a Semantic Measurement and Control Entity (SMCE) is communicatively coupled to the TX UE and the RX UE;
determining, based at least on the received data, a semantic distortion corresponding to the semantic communications session; and
synchronizing, with at least one of the TX UE or the RX UE, semantic data corresponding to the semantic communications session.
